(19) United States
(12) Patent Application Publication
(10) Pub. No.: US 2009/0087766 A1
(43) Pub. Date: Apr. 2, 2009

(54) TONER FOR DEVELOPING ELECTROSTATIC LATENT IMAGE

(75) Inventors: Meizo Shirose, Tokyo (JP); Ryuji Kitani, Tokyo (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/917,856

(22) PCT Filed: Jun. 29, 2005
(86) PCT No.: PCT/JP2005/011945

§ 371 Date: Dec. 17, 2007

(51) Int. Cl. G03G 9/08

(52) U.S. Cl. 430/108.2; 430/108.9

(57) ABSTRACT

The present invention relates to a toner for developing electrostatic latent images, comprising carbon black having a number average particle size of Feret's diameter of 5 to 300 nm and containing primary particles at a content of 5% or more on a number basis.

The toner of the present invention can prevent change of Q/M caused by adhesion of a carrier or a sleeve, and stable characteristics can be maintained for a long period without causing fogging or tone-flying.

### TECHNICAL FIELD

The present invention relates to a toner for developing electrostatic latent images.

### BACKGROUND ART

A black toner for developing electrostatic latent images uses mainly carbon black as a coloring material.

Normally, the carbon black is composed of secondary particles formed by a plurality of basic particles that are chemically and/or physically combined with one another, that is, an aggregate (referred to also as a structure) (FIG. 4). This aggregate has a complex aggregated structure that is branched into irregular chain forms. Since the aggregates are formed into secondary aggregates by a Van der Waals force or through simple aggregation, adhesion, entangling, or the like, it has been difficult to obtain a sufficiently micro-dispersed structure in a binder resin. Therefore, the dispersion of carbon black in toner is irregular, resulting in lack in uniformity of color and lack in uniformity of electrical resistance and it was difficult to obtain toner images in high quality.

Since the carbon black is weak in its affinity to other substances, such as, for example, an organic polymer, water and an organic solvent, in comparison with its aggregating force among mutual particles, it is very difficult to evenly mix or disperse the carbon black under normal mixing or dispersing conditions. For this reason, when carbon black is dispersed in a binder resin, color phases among toner particles become different due to insufficient dispersion, or the carbon black is isolated from the toner during the use of the toner, sometimes causing adverse effects to the image quality.

In order to solve this problem, a number of attempts have been made so as to improve the dispersibility of carbon black, by coating the surface of carbon black with various kinds of surfactants and resins to improve the affinity to the solid-state base material or liquid.

For example, carbon black, which is formed by grafting an organic compound thereon by polymerizing a polymerizable monomer in the coexistence of carbon black (aggregates), has drawn public attention because this carbon black can change its hydrophilic property and/or lipophilic property on demand by appropriately selecting the kind of the polymerizable monomer (for example, U.S. Pat. No. 6,417,283). However, it is difficult to obtain a dispersing property into toner particles in a sufficient level desired by the present inventors. Consequently, in particular, during long-term use, carbon black tends to be isolated from the toner particles to cause a change in the toner quantity of charge, resulting in fogging and toner scattering.

### DISCLOSURE OF INVENTION

### Technical Problems to be Solved

The present invention has been made to solve the above-mentioned problems.

Its objective is to provide an electrostatic latent image developing toner containing carbon black having a number average Feret's diameter in the range from 2 to 300 nm and primary particles that account for 5% or more on a number basis.

Another objective is to provide an electrostatic latent image developing toner that can prevent a change in Q/M due to adhesion to the carrier and sleeve, and is free from fogging and toner scattering and capable of maintaining stable performances for a long time.

### Means to Solve the Problems

The above-mentioned objects can be achieved by the following (1) to (3).

(1) A toner for developing electrostatic latent images, containing carbon black having a number average particle size of Feret's diameter of 5 to 300 nm and primary particles of 5% or more on a number basis.
(2) The toner for developing electrostatic latent images described in the above-mentioned (1), in which the carbon black is surface-treated with an organic compound.
(3) The toner for developing electrostatic latent images described in the above-mentioned (2), in which the organic compound contains at least one of a phenol-based compound and/or an amine-based compound.

With the above-mentioned arrangement, it becomes possible to provide an electrostatic latent image developing toner that allows a desirable image-forming process in an image-forming apparatus which has achieved a small size and high-speed operations, and also to prevent a reduction in Q/M due to adhesion to the carrier and sleeve so that stable performances can be maintained for a long time without causing fogging, toner scattering and the like.

Carbon black aggregates can be formed into primary particles, which have been conventionally considered to be impossible to achieve, and it has not been expected that by allowing toner to contain the stable primary particles, fogging and toner scattering can be reduced.

Carbon Black

### (1) Primary Particles, Secondary Particles

The following description will discuss primary particles of carbon black in the present application. Normally, carbon black is present in an aggregate form, and the aggregate is a form, in which plurality of basic particles are chemically and/or physically aggregated. In the present application, the primary particles of carbon black refer to the basic particles. However, the primary particles do not refer to the basic particles in a state in which the basic particles form an aggregate, but refer to particles that are present stably in a state in which the basic particles are separate from the aggregate. Secondary particles in the present application refer to an aggregate formed by aggregating the basic particles. Here, in the present application, secondary aggregates formed by aggregation of the aggregates are generally referred to as secondary particles.

FIG. 2 is a drawing illustrating the relationship between secondary particles and basic particles. The state formed by aggregating the basic particles is defined as a secondary particle. FIG. 3 represents a state in which basic particles that have formed secondary particles are separated from the secondary particles and are stably maintained, and this particle that is present as a single basic particle is defined as a primary particle.

### (2) Number Average Particle Size of Feret's Diameter

The carbon black used in a toner for developing electrostatic latent images (hereinafter, simply referred to as carbon black) has a number average particle size of Feret's diameter in the range from 5 to 300 nm. The range is preferably from 10 to 100 nm, particularly preferably from 10 to 80 nm.

By using carbon black located within this range, for example, it becomes possible to disperse the carbon black in a binder resin more densely and also to distribute it in a toner evenly so that superior image quality can be achieved. Since carbon black is allowed to have a small particle size as a whole, it is hardly isolated from the toner particles so that a change or the like in the quantity of charge due to the isolation of carbon black hardly occurs.

Here, an object to be measured in a number average particle size of Feret's diameter is each of the primary particles and the secondary particles of carbon black that are present in a stable state. In the case of carbon black that is present as an aggregate, the aggregate is the object to be measured, and the basic particles in the aggregate are not measured.

The controlling process into this number average particle size can be achieved by the following operations: the particles of the carbon black that are present as an aggregate and have basic particle sizes within the above-mentioned range are properly selected and processed, or conditions during the production process for dividing the aggregate into primary particles are altered.

The number average particle size of Feret's diameter can be observed by means of an electron microscope.

Upon finding the number average particle size of Feret's diameter from carbon black simple substance, an enlarged photograph may be taken at magnification of 100000 by using a scanning electron microscope (SEM), and 100 particles may be properly selected to calculate the number average particle size of Feret's diameter.

In the case when the average particle size of carbon black is found from a molded product such as a resin, an enlarged photograph may be taken at magnification of 100000 by using a transmission electron microscope (TEM), and 100 particles may be properly selected to calculate the number average particle size.

The Feret's diameter, used in the present invention, refers to the largest length in a predetermined one direction of each of carbon black particles, among carbon black particles photographed by using the above-mentioned electron microscope. The largest length represents a distance between parallel lines, that is, two parallel lines that are drawn perpendicular to the predetermined one direction so as to be made in contact with the outer diameter of each particle.

For example, in FIG. 1, with respect to a photograph 300 of carbon black particles 200 taken by using an electron microscope, one direction 201 is arbitrarily determined. The distance between two straight lines 202 that are perpendicular to the predetermined direction 201 and made in contact with each carbon black particle 200 represents a Feret's diameter 203.

The carbon black contains primary particles and the primary particles are preferably designed to have a number average particle size of Feret's diameter 2 to 100 nm, and particularly 3 to 80 nm. By using the carbon black within this range, a micro-dispersed structure is promoted. The method for measuring the number average particle size of the primary particles of carbon black is the same as the measuring method for the number average particle size of the above carbon black. Here, the number of measured particles corresponds to 100 primary particles.

### (3) Rate of Primary Particles

Carbon black of the present embodiment contains 5% or more of primary particles in carbon black on a number basis. The upper limit is 100%. In the case of an aggregate, particle fragmentation tends to occur at aggregated portions to cause isolation of carbon black; however, since primary particles are not an aggregate, no fragmentation occurs in the particle and the isolation hardly occurs. The content of 5% or more makes it possible to improve the dispersibility of carbon black inside the toner, to reduce deviations among toner particles, to effectively prevent fogging and toner scattering, and consequently to provide an image with high picture quality.

With respect to the rate of primary particles, as the rate becomes greater, the powder characteristic of the entire carbon black is further uniformed; therefore, the handling becomes easier, the conductivity and coloring property in the toner particles are uniformed, and the variations become smaller so that it becomes possible to effectively prevent fogging and toner scattering, and consequently to provide an image with high picture quality. Even under stress inside the developing machine, such as stirring and mixing, since the carbon black is hardly isolated, the range of variations in the quantity of charge in the toner particles is reduced, and adhesion of toner particles and carbon black to the developing sleeve or the like can be prevented. For this reason, the quantity of charge can be stabilized and the developer performance can be maintained in a stable manner for a long time.

More specifically, the better results can be obtained in the order of 10% or more, 20% or more, 30% or more, 40% or more and 50% or more. Upon measuring the rate of the primary particles, the same process as described above is carried out by using the electron microscope, and the number of measured particles is calculated by counting primary particles that are present in 1000 carbon black particles.

### (4) Carbon Black

The carbon black of the present invention is preferably designed so that the surface of each of carbon black particles that are stably present finally is surface-treated (including a graft treatment) with an organic compound or the like.

The carbon black of the present invention is preferably subjected to a graft treatment at least on its surface with an organic compound that has active free radicals or is capable of producing active free radicals, which will be described later. With this arrangement, it is possible to improve the dispersing property onto a medium.

The rate of graft treatment of the organic compound to the carbon black is preferably set to 50% or more. The rate of graft treatment is determined in the following manner.

Supposing that the amount of an organic compound prior to the reaction is Y and that the extracted organic compound is Z, the rate of graft treatment is represented by ((Y−Z)/Y)×100(%).

### (5) Production Method of Carbon Black

The following description will discuss a preferable production method of carbon black in accordance with the present invention.

A preferable production method to be applied to the present invention is provided with at least the following processes:

(A) Surface treatment process, in which the surface of carbon black containing secondary particles made of at least aggregates (structure) of basic particles is treated with an organic compound that has active free radicals or is capable of producing active free radicals; and
(B) A process, in which, by applying a mechanical shearing force to the carbon black containing at least secondary particles to give primary particles, and an organic compound is grafted onto a separation face from which the separation is made from the secondary particle.

The following description will discuss the processes (A) and (B) in detail.

(A) The surface treatment process, in which at least the surface of carbon black containing secondary particles made of at least aggregates (structure) of basic particles is treated with an organic compound that has active free radicals or is capable of producing active free radicals.

In this process, the surface of carbon black composed of aggregates (structure) is surface-treated with the above-mentioned organic compound.

In the present process, radicals are generated on the surface of a structure that is the minimum aggregation unit by applying heat or a mechanical force thereon, and the surface treatment is carried out by using an organic compound capable of capturing the radicals. By this process, re-aggregated portions that have been aggregated again by a strong aggregating force between the carbon blacks can be effectively reduced, so that the structure and the primary particles of the carbon black can be prevented from being aggregated and adhered.

The surface treatment includes a process in which an organic compound is adsorbed on the surface and a process in which the organic compound is grafted thereon. In order to stabilize the particles that have been formed into primary particles, the organic compound is preferably grafted onto the entire surface of a secondary particle at portions except for the surface where separation is made from the secondary particle. In order to allow the primary particles to be stably present after the grafting process, which will be described later, it is preferable to graft the organic compound onto the surface of the carbon black in this process.

With respect to the method for the surface treatment, for example, a method in which carbon black aggregates and an organic compound that has active free radicals or is capable of generating active free radicals are mixed with each other may be used. The surface treatment preferably includes a mixing process in which a mechanical shearing force is applied. That is, it is presumed that, in the process in which the mechanical shearing force is applied thereto, the surface of secondary particles of the carbon black is activated, and that the organic compound itself is activated by the shearing force to easily form a radicalized state, with the result that the grafting process of the organic compound onto the surface of the carbon black is easily accelerated.

In the surface treatment process, a device that is capable of applying a mechanical shearing force is preferably used.

The preferable mixing device to be used in the surface treatment process includes: a Polylabo System Mixer (Thermo Electron Co., Ltd.), a refiner, a single-screw extruder, a twin-screw extruder, a planetary extruder, a cone-shaped-screw extruder, a continuous kneader, a sealed mixer, a Z-shaped kneader and the like.

When upon carrying out the surface treatment, the above-mentioned device is used, the degree of filling of mixture in the mixing zone of the mixing device is preferably set to 80% or more. The degree of filling is found by the following equation:

Z=Q/A

Z: degree of filling (%) Q: volume of filled matter (m²) A: volume of cavity of mixing section (m²)

In other words, by providing a highly filled state during the mixing process, the mechanical shearing force can be uniformly applied to the entire particles. When the degree of filling is low, the transmission of the shearing force becomes insufficient to fail to accelerate the activity of the carbon black and the organic compound, with the result that the grafting process might hardly progress.

During the mixing process, the temperature of the mixing zone is set to the melting point of the organic compound or more, preferably within the melting point +200° C., more preferably within the melting point +150° C. In the case when a plurality of kinds of organic compounds are mixed, the temperature setting is preferably carried out with respect to the melting point of the organic compound having the highest melting point.

During the mixing process, irradiation of electromagnetic waves, such as ultrasonic waves, microwaves, ultraviolet rays and infrared rays, ozone function, function of an oxidant, chemical function and/or mechanical shearing force function may be used in combination so that the degree of the surface treatment and the process time can be altered. The mixing time is set to 15 seconds to 120 minutes, although it depends on the desired degree of the surface treatment. It is preferably set to 1 to 100 minutes.

The organic compound to be used for the surface treatment is added to 100 parts by weight of carbon black, within the range from 5 to 300 parts by weight, to carry out the surface treatment process. More preferably, it is set to 10 to 200 parts by weight. By adding the organic compound within this range, it is possible to allow the organic compound to uniformly adhere to the surface of the carbon black, and also to supply such a sufficient amount that the organic compound is allowed to adhere to separated faces to be generated at the time when the secondary particles are formed. For this reason, it becomes possible to effectively prevent decomposed primary particles from again aggregating, and also to reduce the possibility of losing inherent characteristics of the carbon black in the finished carbon black, due to an excessive organic compound contained therein when excessively added beyond the above-mentioned amount of addition.

(B) The process in which, by applying a mechanical shearing force to carbon black containing at least secondary particles to give primary particles, and an organic compound is grafted onto separated faces from which the separation is made from the secondary particle.

The present process corresponds to a process in which the carbon black having reduced re-aggregation portions by the surface treatment process is cleaved so that secondary particles are formed into primary particles and the organic compound is grafted onto the surface thereof so that stable primary particles are formed. That is, for example, a mechanical shearing force is applied to the carbon black that has been surface-treated with the organic compound, and while the aggregated portion of basic particles is being cleaved, the organic compound is grafted onto the cleaved portion so that the re-aggregation of the carbon black is suppressed. When the mechanical shearing force is continuously applied to the carbon black, the cleaved portion is expanded, and the organic compound is grafted onto the separated faces caused by the cleavage while being formed into primary particles. Thus, at the time when the separation is finally made to form primary particles, no active portions capable of aggregating are present so that stable primary particles are prepared. In this case, since the same mechanical shearing force is also applied to the added organic compound, the organic compound itself is activated by the mechanical shearing force so that the graft treatment is accelerated.

The above-mentioned grafting process is a process in which an organic compound that has active free radicals or is capable of producing active free radicals is grafted onto at least a cleaved portion; however, the grafting process may be simultaneously carried out at portions other than the cleaved portion. The grafting process may be carried out simultaneously, while the surface treatment process is being executed, or may be carried out as a separated process.

With respect to the means used for causing the cleavage, various methods, which include irradiation of electromagnetic waves, such as ultrasonic waves, microwaves, ultraviolet rays and infrared rays, ozone function, function of an oxidant, chemical function and mechanical shearing function, may be adopted.

In the present production method, the cleavage is preferably caused by applying at least a mechanical shearing force. Carbon black (structure), surface-treated with an organic compound, is placed in a place where a mechanical shearing force is exerted, and the surface-treated carbon black is preferably treated to give primary particles from the structure. Upon applying the mechanical shearing force, any of the above-mentioned methods used for causing the cleavage may be used in combination.

The same shearing force as the mechanical shearing force used in the surface treatment process is preferably used as the mechanical shearing force in this process.

As described above, the function of the mechanical shearing force is used not only for forming carbon black into fine particles from aggregates to primary particles, but also for cutting chains inside the carbon black to generate active free radicals. The organic compound, which is used in the present production method, and has free radicals or is capable of generating free radicals, includes, for example, an organic compound that is divided by receiving, for example, a function of the field of the mechanical shearing force to be allowed to have or generate active free radicals. In the case when the active free radicals are not sufficiently generated only by the function of the mechanical shearing force, the number of the active free radicals may be compensated for, by using irradiation with electromagnetic waves, such as ultrasonic waves, microwaves, ultraviolet rays and infrared rays, function of ozone or function of an oxidant.

With respect to the device for applying the mechanical shearing force, for example, the following devices may be used: a Polylabo System Mixer (Thermo Electron Co., Ltd.), a refiner, a single-screw extruder, a twin-screw extruder, a planetary extruder, a cone-shaped-screw extruder, a continuous kneader, a sealed mixer and a Z-shaped kneader. With respect to the conditions under which the mechanical shearing force is applied, the same conditions as those in the aforementioned surface treatment process are preferably used from the viewpoint of effectively applying the mechanical shearing force. By using these devices, the mechanical energy is uniformly applied to the entire particles effectively as well as continuously so that the grafting process can be preferably carried out effectively as well as uniformly.

In the above-mentioned surface treatment process and grafting process, the organic compound to be added may be gradually added continuously or intermittently so as to be set to a predetermined amount thereof, or a predetermined amount thereof may be added at the initial stage of the surface treatment process, and processes up to the grafting process may be executed.

With respect to the organic compound to be used for the surface treatment process as a material for the surface treatment and the organic compound to be used for the grafting process as a material to be graft-reacted, the same compounds may be used, or different compounds may be used.

The above-mentioned grafting process is preferably carried out under the condition of the melting point of the used organic compound or more. The upper limit of the temperature condition is preferably set, in particular, within the melting point +200° C., more preferably within the melting point +150° C. from the viewpoints of accelerating the grafting reaction and the division into primary particles. In the case when a plurality of kinds of organic compounds are mixed, it is preferable to carry out the temperature setting with respect to the melting point of the organic compound having the highest melting point.

The period of time during which the mechanical shearing force is applied is preferably set within the range from 1 to 100 minutes so as to sufficiently execute the process, from the viewpoint of improving the homogeneity of the reaction.

In the above-mentioned production method, the mechanical shearing force is preferably applied thereto by mixing carbon black and an organic compound that will be described later, without using a solvent. Since the shearing force is applied at a temperature of the melting temperature of the organic compound or more during the reaction, the organic compound is formed into a liquid state and well attached to the surface of the carbon black that is a solid substance uniformly so that the reaction is allowed to proceed effectively. In the case when a solvent is used, although the homogeneity is improved, the transmission of energy is lowered upon applying the mechanical shearing force to cause a low level of activation, with the result that it presumably becomes difficult to effectively carry out the grafting process.

Here, with respect to the method for adjusting the amount of the primary particles, although not particularly limited, it can be adjusted by changing the conditions under which the aforementioned mechanical shearing force is applied. More specifically, the degree of filling of mixture in the mixing zone of the mixing device used for applying the shearing force is set to 80% or more, and by changing the degree of filling, the mechanical shearing force is altered so that the rate of presence of the primary particles can be adjusted. The rate can be adjusted by changing the stirring torque at the time of mixing, and the torque can be adjusted by controlling the number of stirring revolutions and the stirring temperature, in addition to the control of the degree of filling. More specifically, when the temperature is made lower at the time of mixing, the viscosity of the organic compound in the molten state tends to increase, and the torque becomes higher to consequently increase the shearing force. That is, the content of the primary particles increases.

2) Carbon Black as Starting Material

Examples of an applicable carbon black include furnace black, channel black, acetylene black, Lamp Black, and the like and any of these are commercially available and carbon blacks having an aggregate structure. This aggregate structure has “a structure constitution” formed with primary particles or basic particles aggregated, which means a so-called carbon black formed into secondary particles, made of an aggregate of the primary particles. In order to smoothly carry out the surface treatment and grafting reaction of an organic compound onto carbon black, sufficient amounts of oxygen-containing functional groups, such as a carboxyl group, a quinone group, a phenol group and a lactone group, and active hydrogen atoms on the layer face peripheral edge, are preferably placed on the surface of the carbon black. For this reason, the carbon black to be used in the present invention is preferably allowed to have an oxygen content of 0.1% or more and a hydrogen content of 0.2% or more. In particular, the oxygen content is 10% or less and the hydrogen content is 1% or less. Each of the oxygen content and the hydrogen content is found as a value obtained by dividing the number of oxygen, elements or hydrogen elements by the total number of elements (sum of carbon, oxygen and hydrogen elements).

By selecting these ranges, it is possible to smoothly carry out the surface treatment and grafting reaction of an organic compound onto carbon black.

By selecting the above-mentioned ranges, an organic compound that has free radicals or is capable of generating free radicals is certainly grafted onto carbon black so that the re-aggregation preventive effect can be improved. In the case when the oxygen content and hydrogen content of the carbon black surface are smaller than the above-mentioned ranges, a gaseous phase oxidizing process, such as a heated air oxidization and an ozone oxidization, or a liquid phase oxidizing process by the use of nitric acid, hydrogen peroxide, potassium permanganate, sodium hypochlorite, or bromine water, may be used to increase the oxygen content and the hydrogen content of the carbon black.

3) Organic Compound

An organic compound to be used for surface-treating carbon black in the surface treatment, or to be grafted onto carbon black in the grafting process, corresponds to an organic compound that has free radicals or is capable of generating free radicals.

In the organic compound that is capable of generating free radicals, although not particularly limited, the condition for generating free radicals requires a state in which the organic compound possesses free radicals during the grafting process, in the case of the organic compound to be used in the present invention. With respect to the organic compound, a compound capable of generating free radicals by at least electron movements, a compound capable of generating free radicals through thermal decomposition and a compound capable of generating free radicals derived from cleavage of the compound structure due to a shearing force or the like, may be preferably used.

With respect to the organic compound that has free radicals or is capable of generating free radicals, its molecular weight is preferably 50 or more, and the upper limit is preferably 1500 or less. By adopting the organic compound having a molecular weight within this range, it is possible to form carbon black whose surface is substituted by an organic compound having a high molecular weight to a certain degree, and consequently to restrain the resulting primary particles from being re-aggregated. By using the organic compound having a molecular weight of 1500 or less, an excessive surface modification can be avoided, and the characteristics of the organic compound grafted onto the surface are prevented from being excessively exerted; thus, it becomes possible to sufficiently exert the characteristics of the carbon black itself.

With respect to the organic compound to be used for the surface treatment process and the organic compound to be used for the grafting process, the same compound may be used, or different compounds may be used, and a plurality of kinds of organic compounds may be added to the respective processes. In order to control the reaction temperatures and simplify the other conditions, the same organic compound is preferably used for the surface treatment process as well as for the grafting process.

Examples of the organic compound include organic compounds that can capture free radicals on the surface of carbon black, such as a phenol-based compound, an amine-based compound, a phosphate-based compound and a thioether-based compound.

So-called antioxidants and photostabilizers are preferably used as these organic compounds. More preferably, hindered-phenol based ones and hindered-amine based ones may be used. Those antioxidants of phosphate ester-based compounds, thiol-based compounds and thioether-based compounds may also be used. A plurality of these organic compounds may be used in combination. Depending on the combinations thereof, various characteristics for the surface treatment can be exerted.

In order to positively control the reaction, these organic compounds are preferably the ones not having an isocyanate group. That is, in the case when an organic compound having an excessive reactivity is used, it becomes difficult to provide a uniform grafting reaction, sometimes resulting in a prolonged reaction time and a large quantity of the organic compound to be used. Although not clearly confirmed, the reason for this is presumably because in the case of using an organic compound having a high reactivity as described above, the reaction tends to progress at points other than the surface active points, with the result that the reaction to the active points formed by the mechanical shearing force, which is an original object, becomes insufficient.

Specific examples of the organic compound are shown below:

### Phenol-Based Compounds

(Organic compounds 1 to 88)

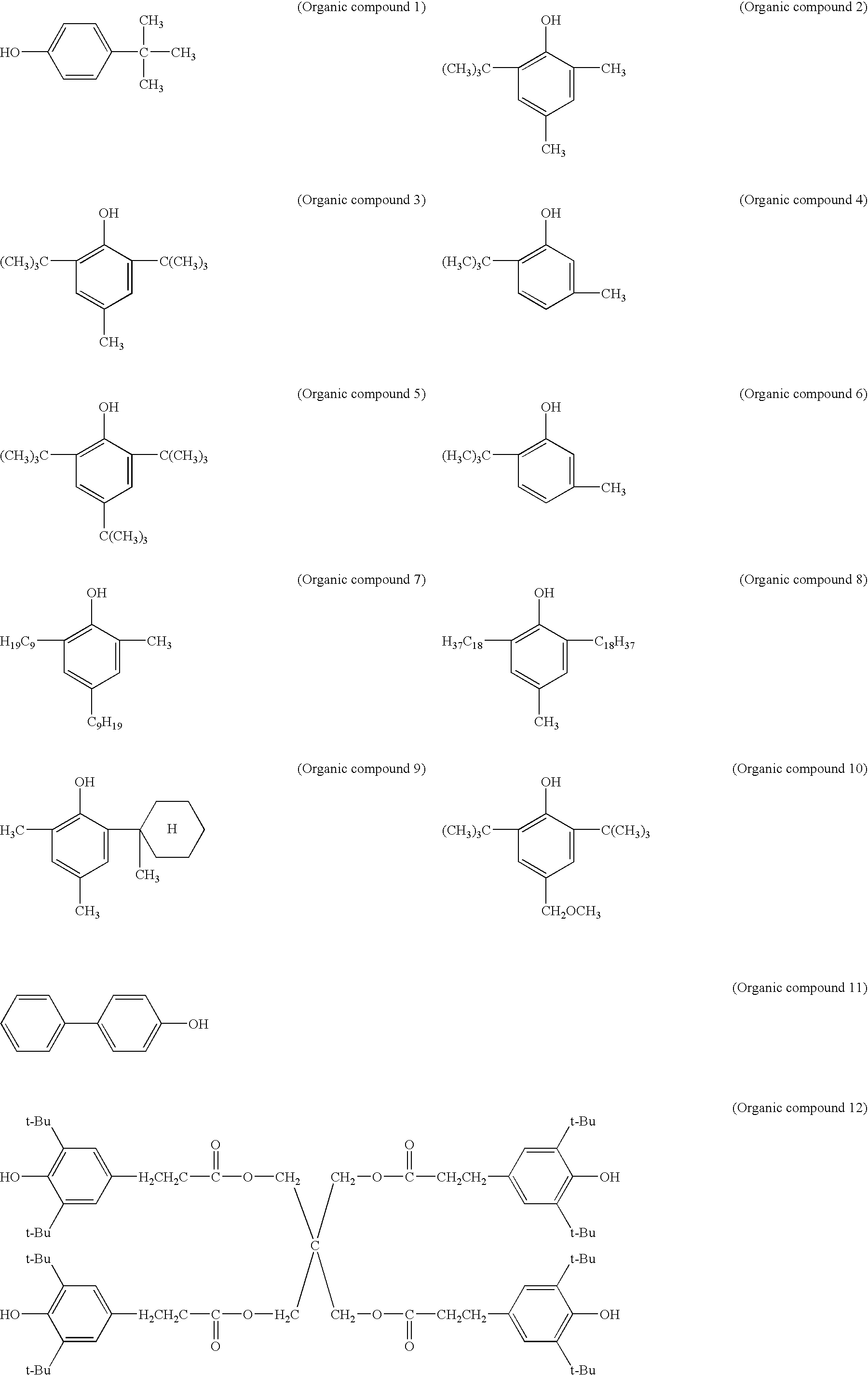

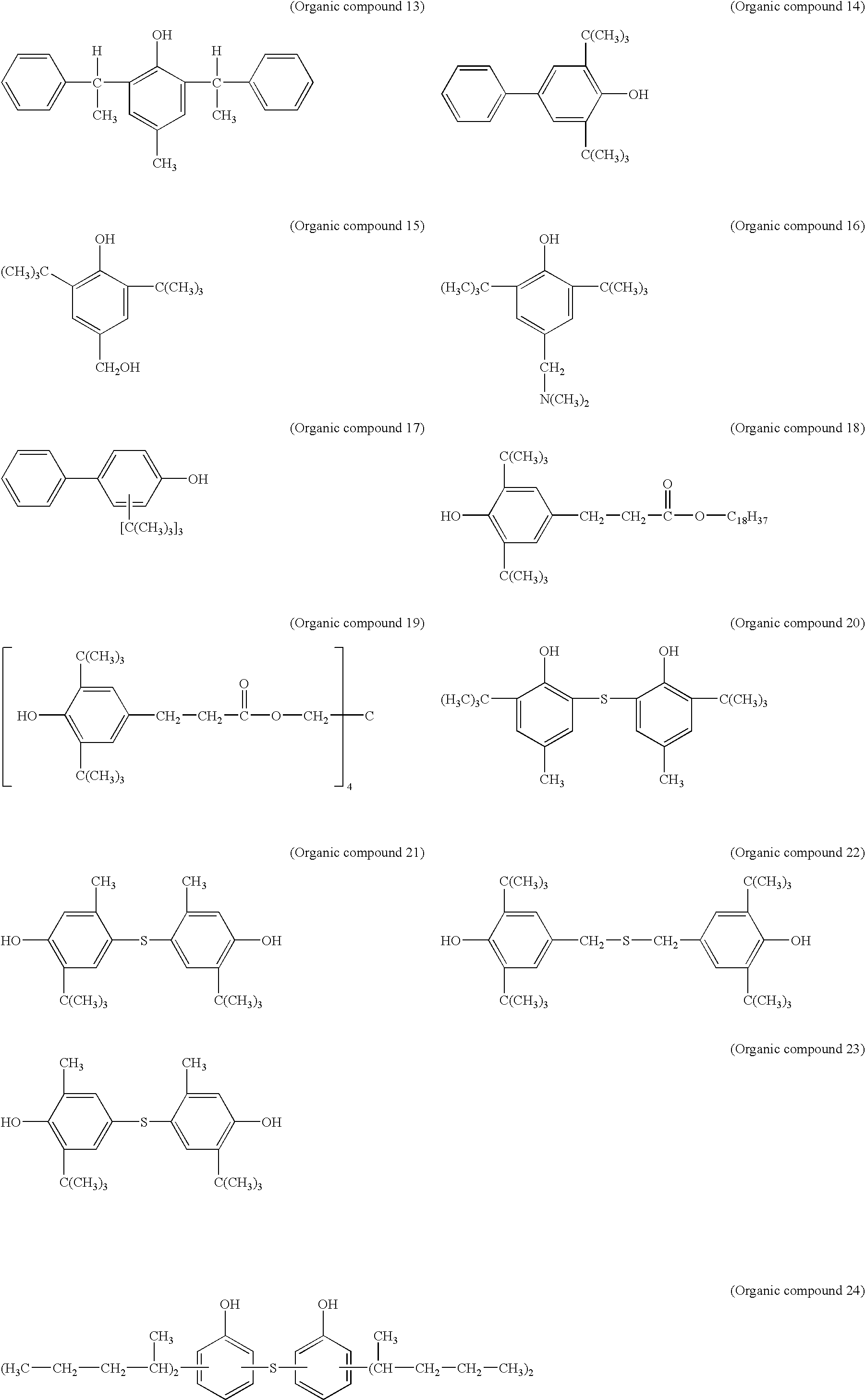

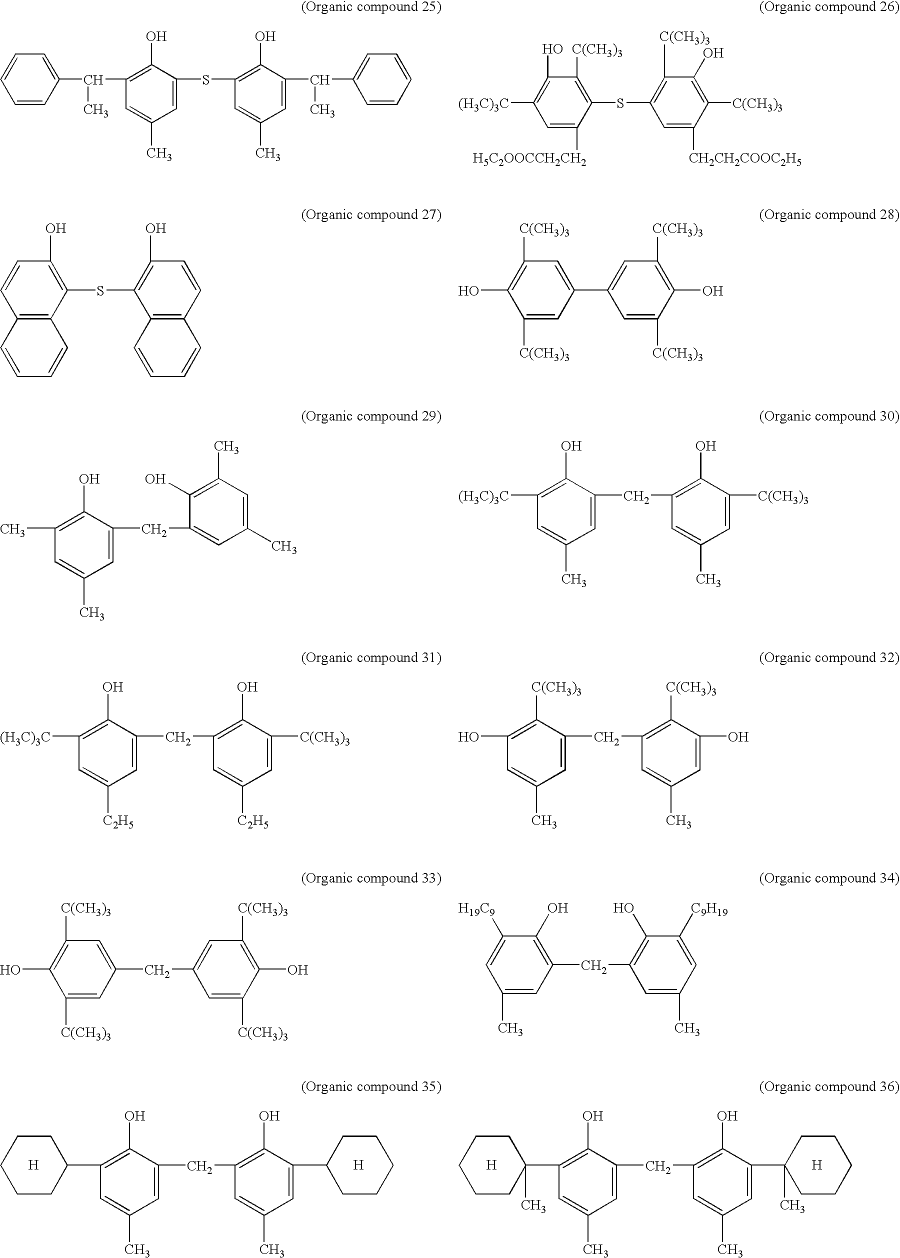

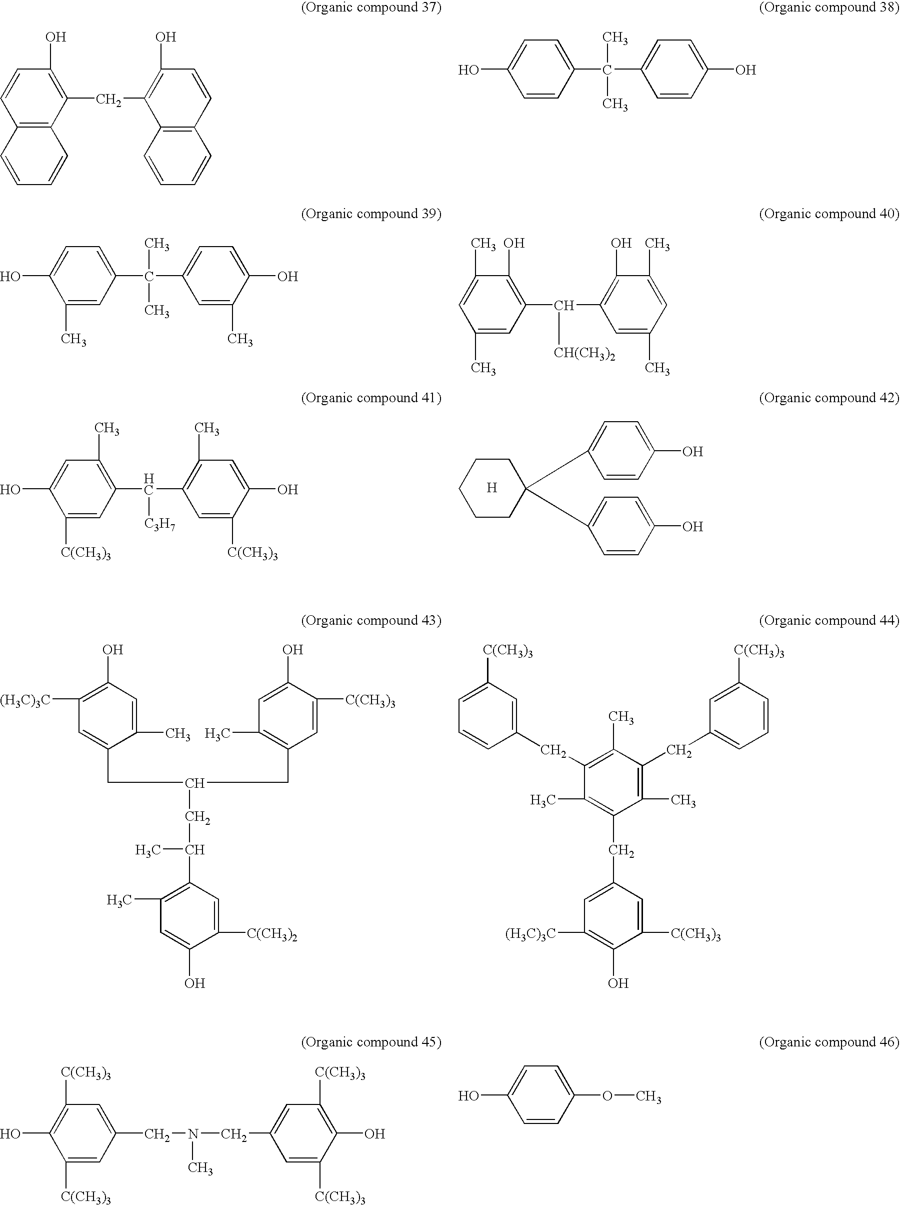

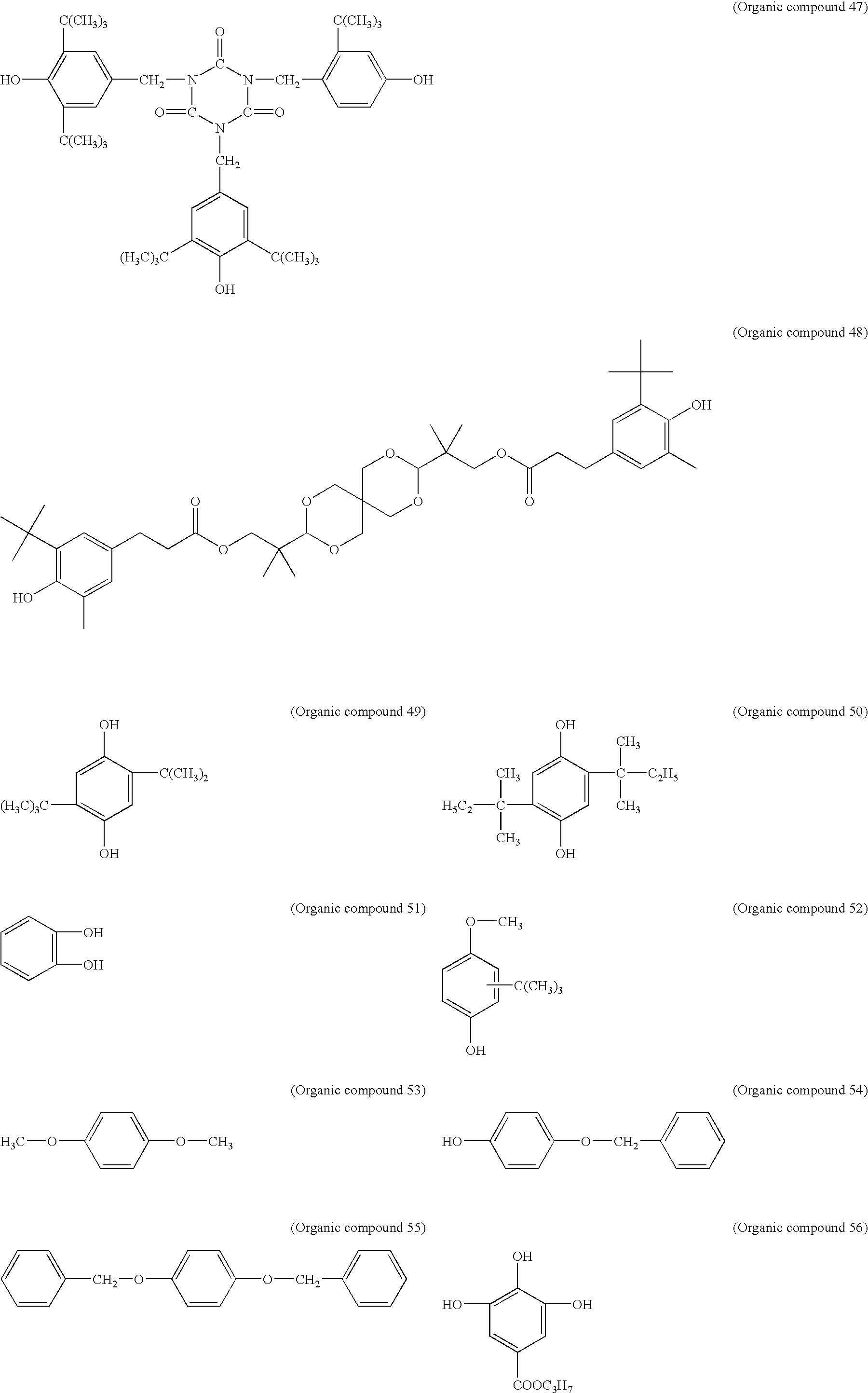

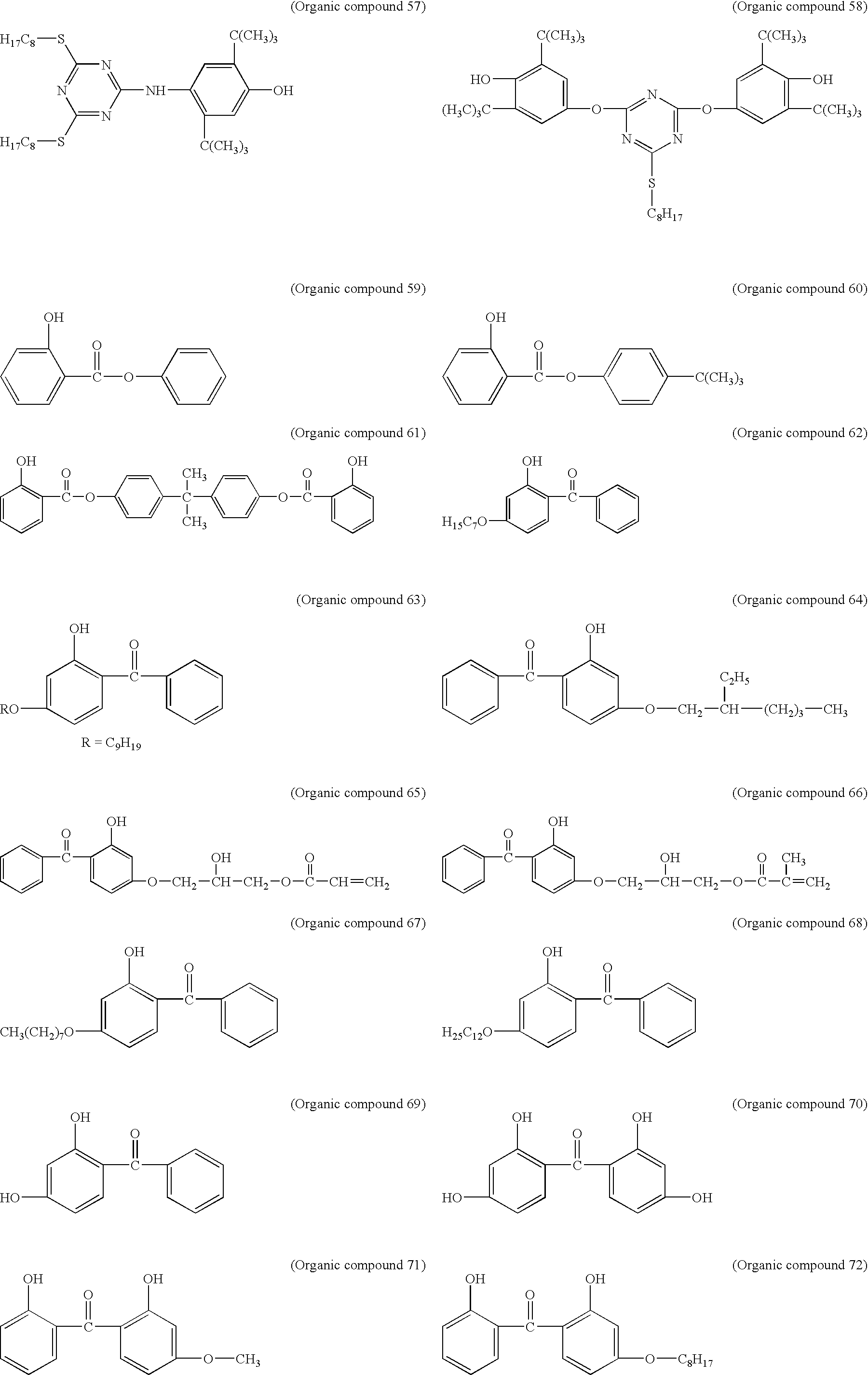

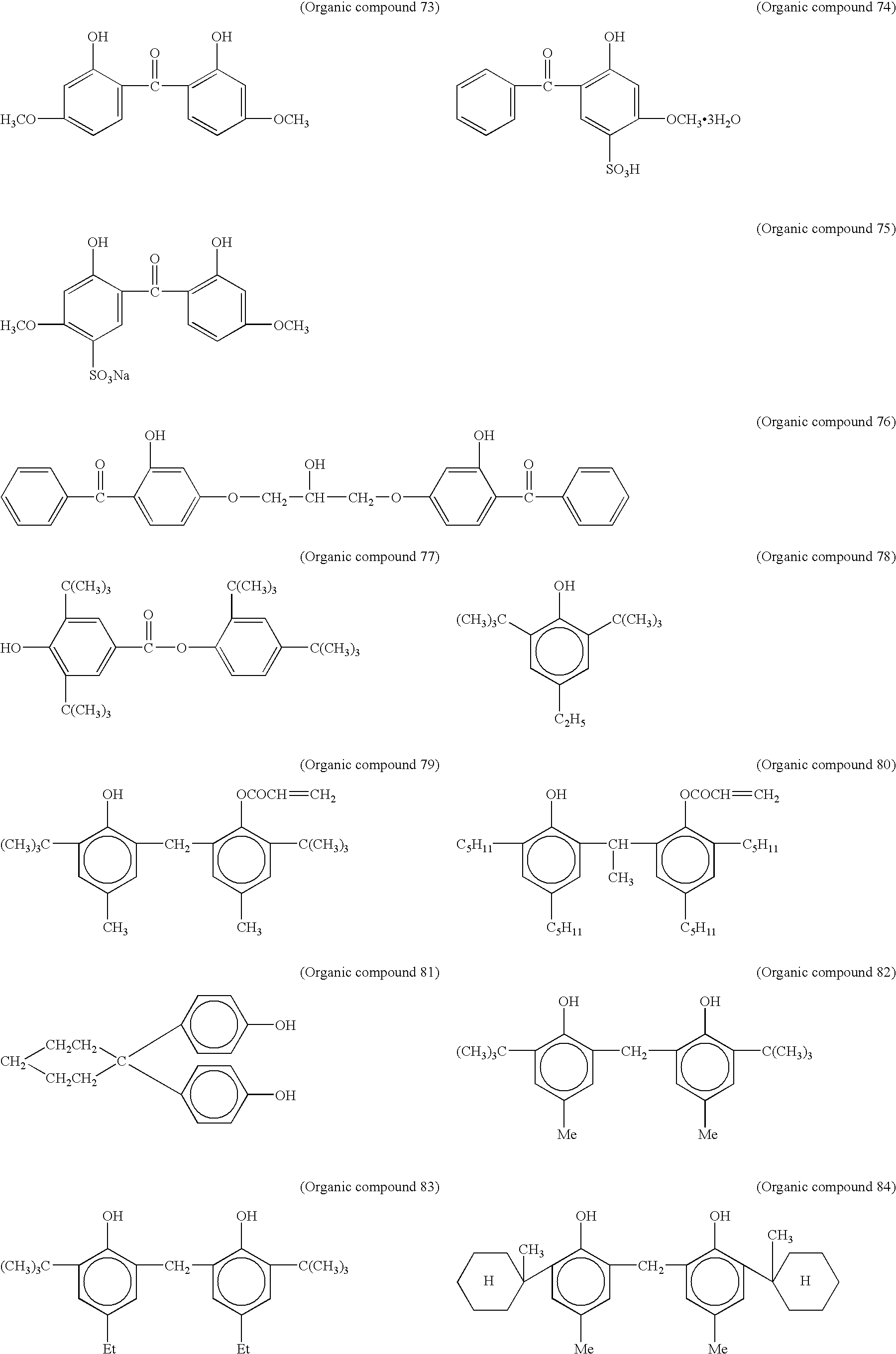

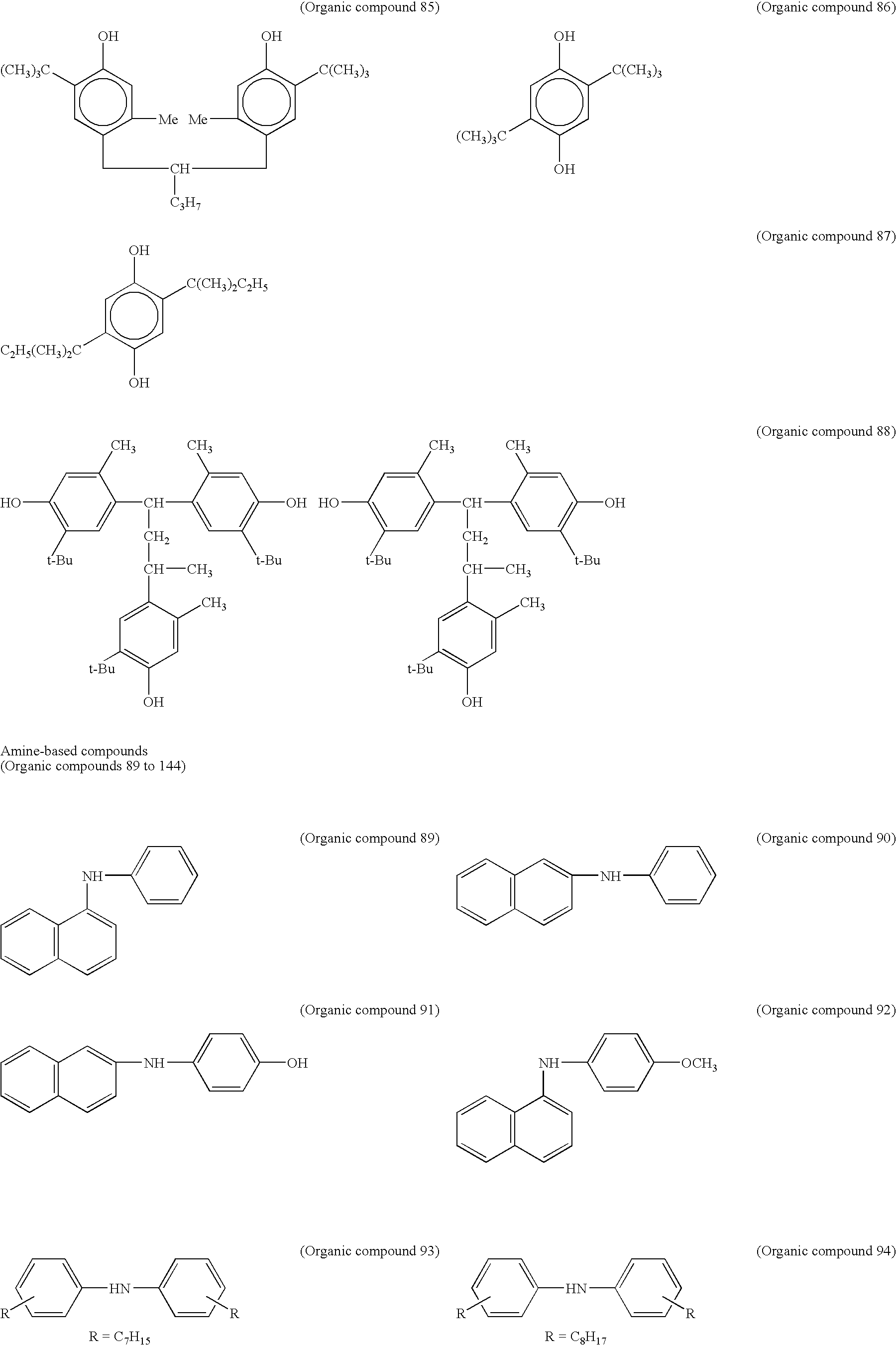

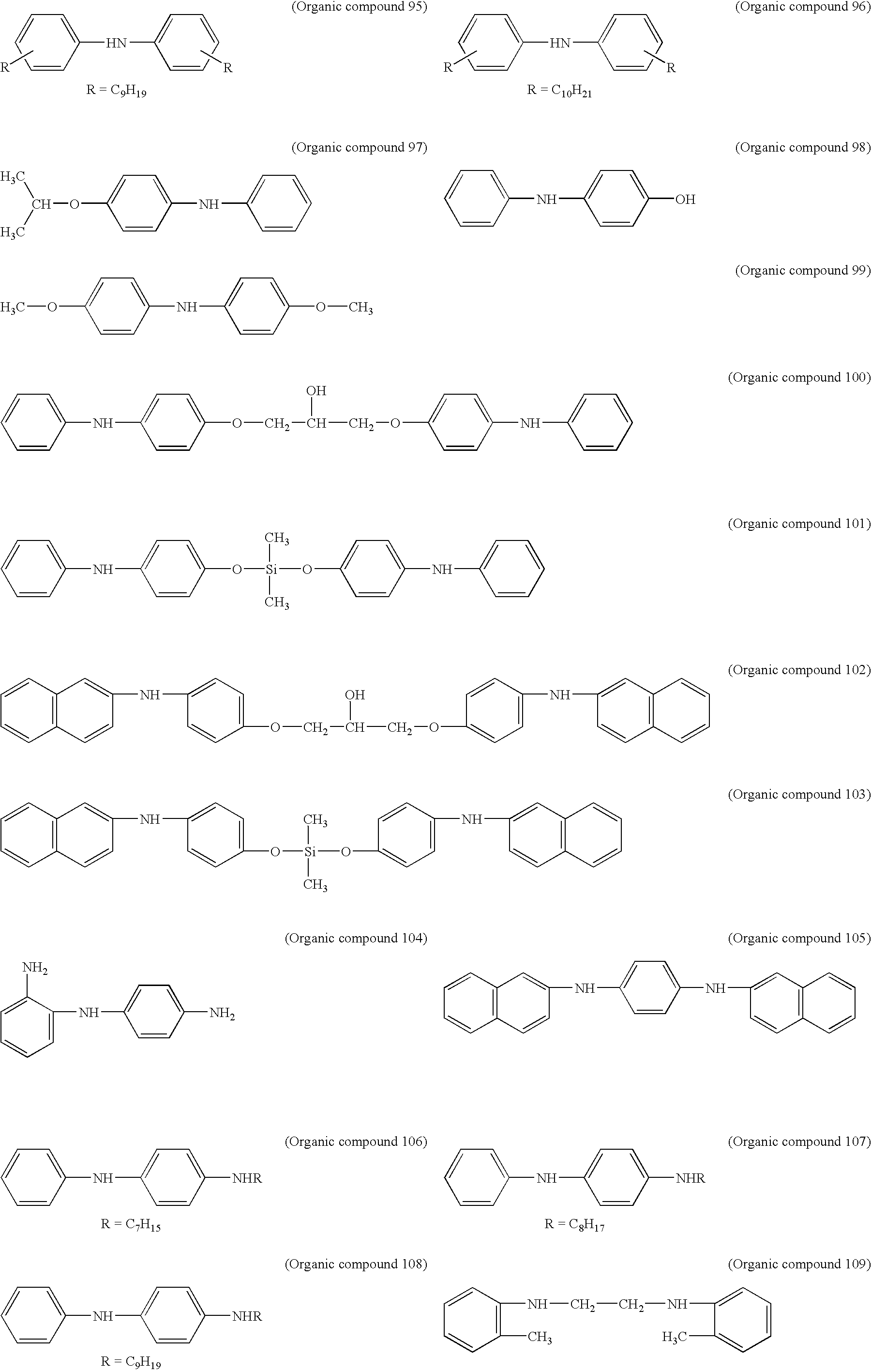

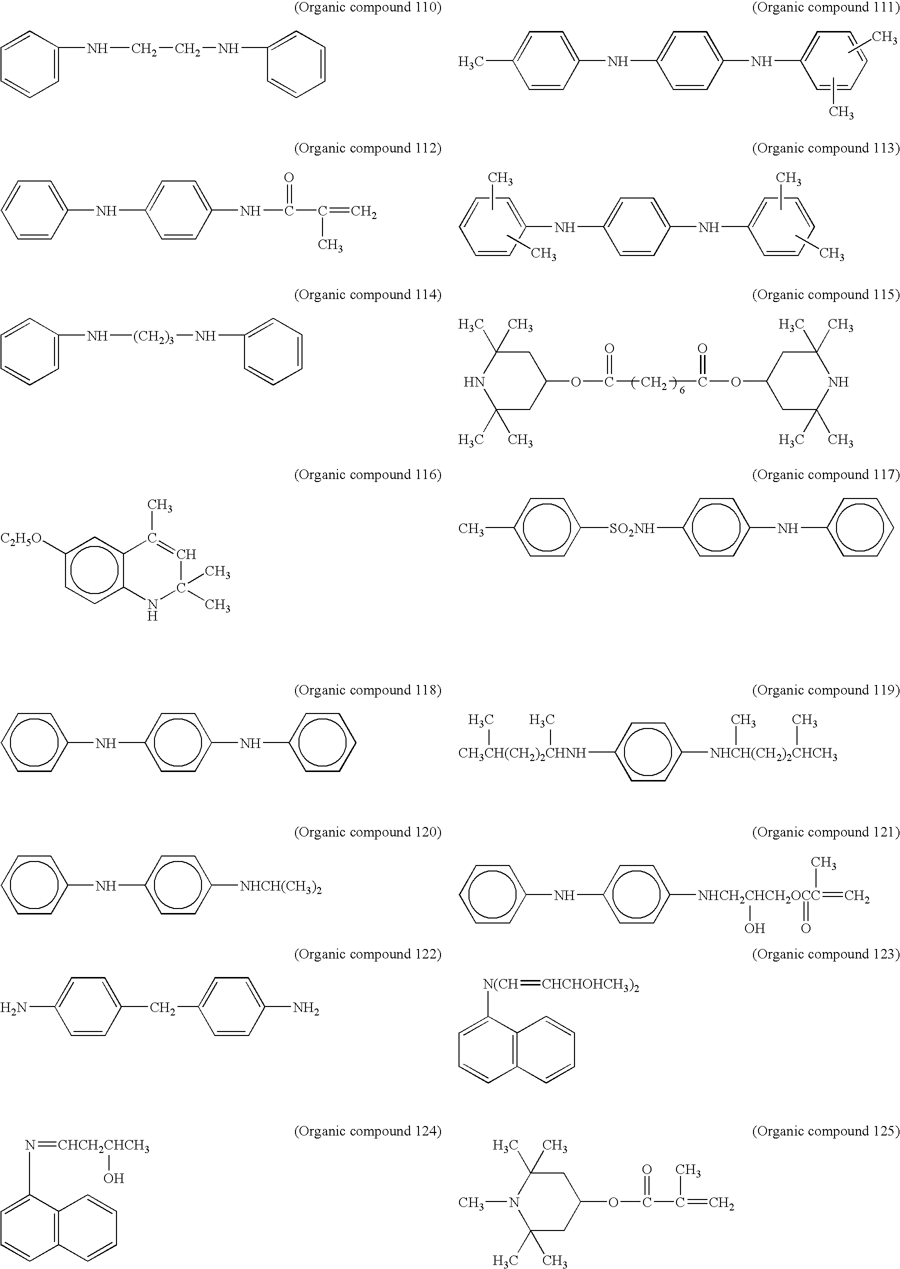

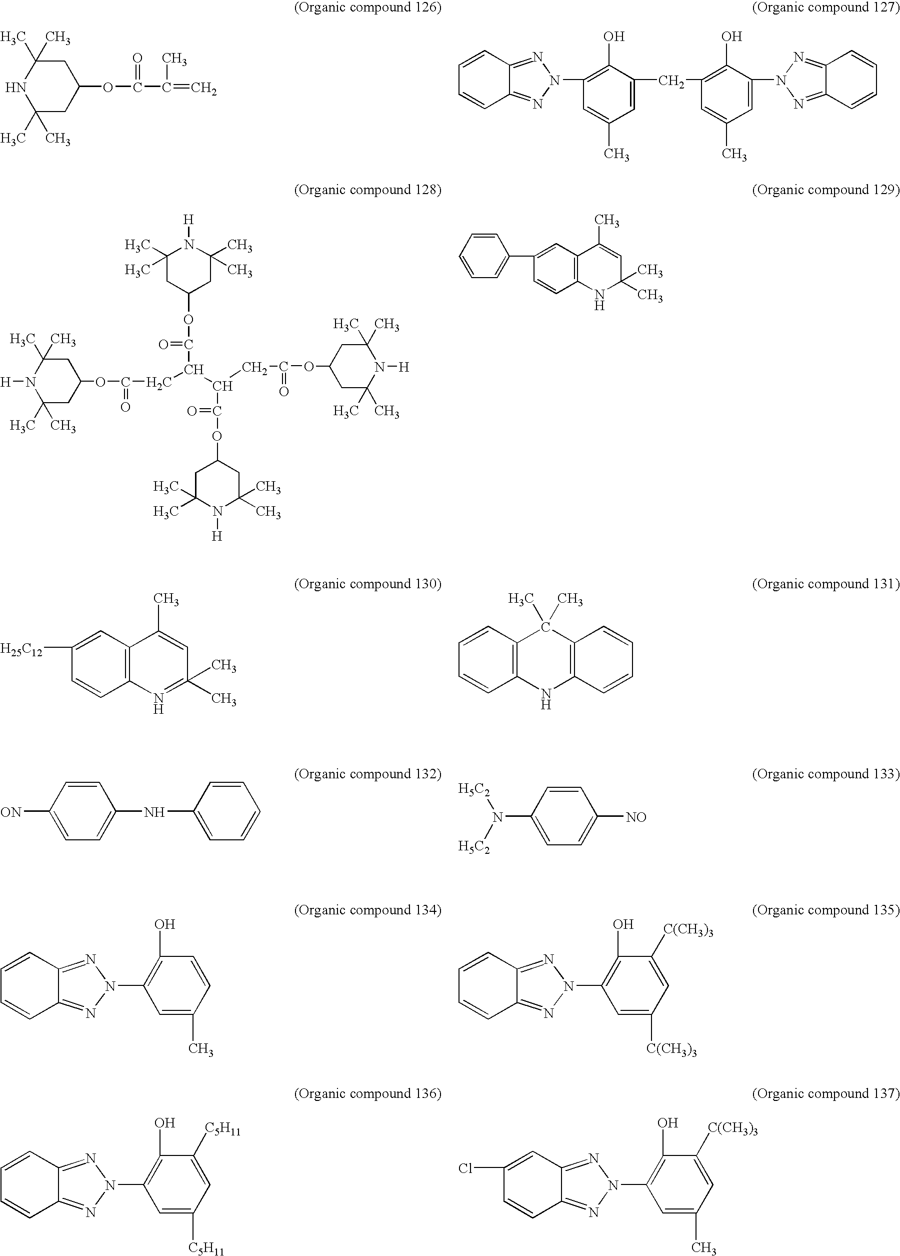

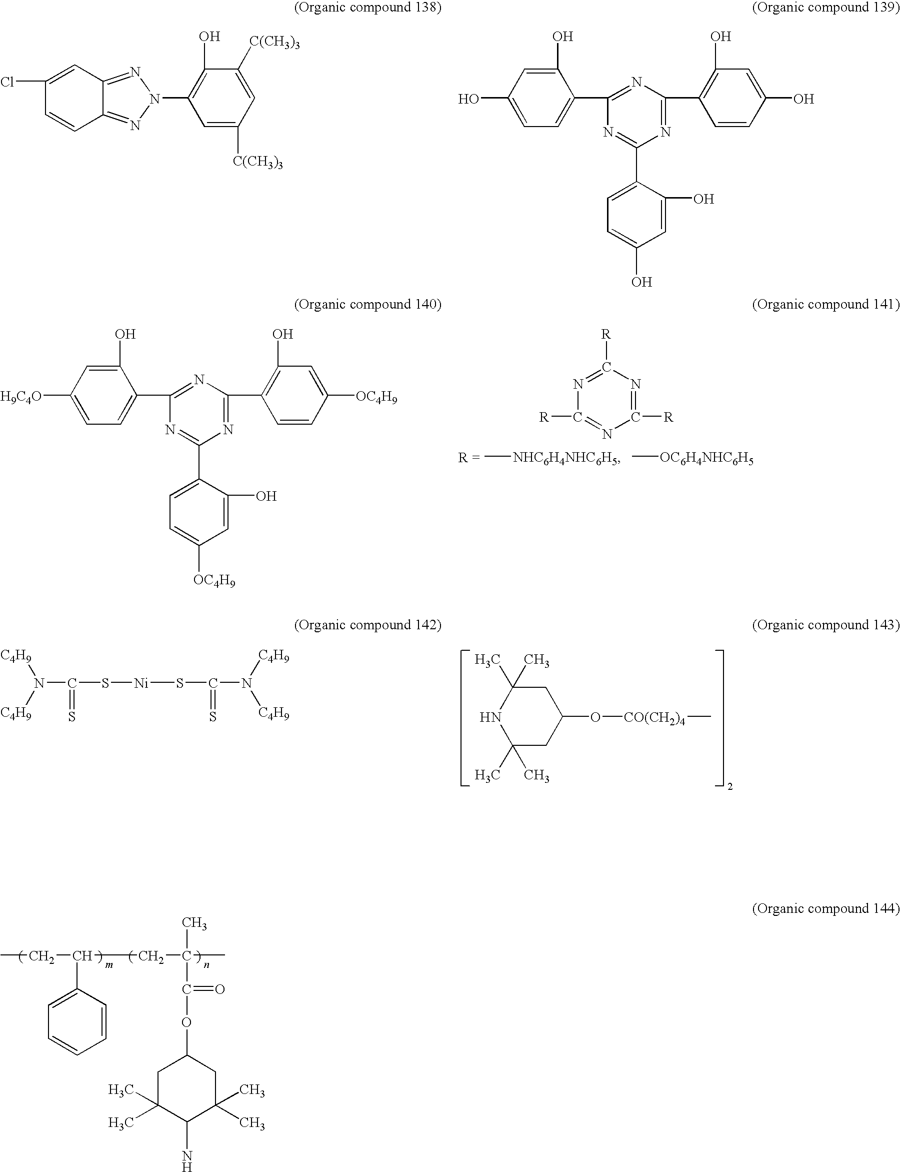

### Thiol-Based and Thioether-Based Compounds

(Organic Compounds 145 to 153)

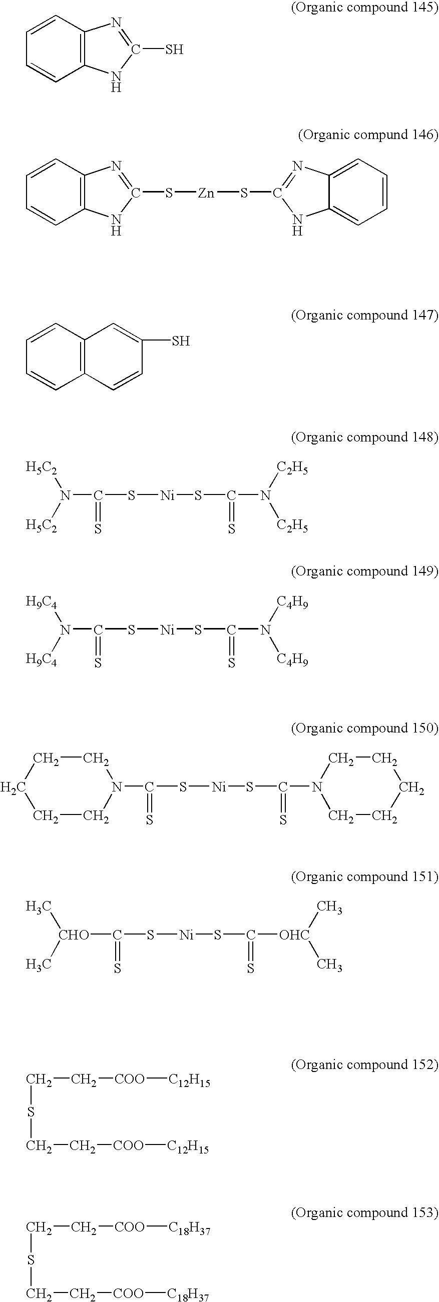

### Phosphate Ester-Based Compounds

### (Organic Compounds 154 to 160)

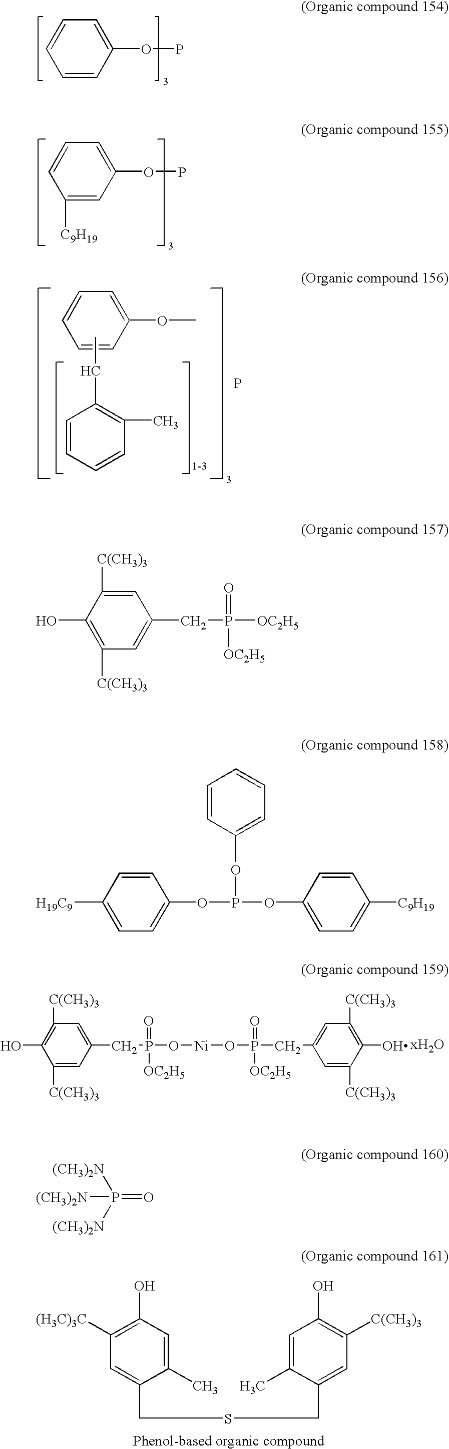

Electrostatic Latent Image Developing Toner

The following description will discuss the electrostatic latent image developing toner.

### 1) Toner Particle Size

The particle size of the toner is preferably set to a median diameter (D50) in the range from 3 μm to 10 μm in the grain distribution on the number basis, more preferably to 3 μm to 8 μm. The particle size can be controlled by classification in the case of the pulverizing method, and in the case of a toner manufacturing method, which will be described later, it can be controlled by the concentration of a coagulant, the added amount of an organic solvent, the fusing time and the composition of a polymer.

By setting the number average particle size to 3 μm to 10 μm, it becomes possible to reduce toner fine particles having a high adhesive strength, which scatter in the fixing process to adhere to heating members to cause offsetting, and consequently to achieve high transferring efficiency so that the half-tone picture quality is improved and the picture quality in fine lines and dots can be improved.

The median diameter of toner on the number basis can be measured by using a Coulter Multisizer (made by Beckman Coulter, Inc.).

In the present invention, the Coulter Multisizer to which an interface (made by Nikkakiki* Co., Ltd.) and a personal computer used for outputting the particle distribution are connected was used. The aperture of the Coulter Multisizer was set to 100 μm, and the number distribution of toner particles of 2 μm or more (for example, 2 μm to 40 μm) was measured so that the particle distribution and the median diameter were calculated.

<<Manufacturing Process for Electrostatic Latent Image Developing Toner>>

The following description will discuss the manufacturing process of an electrostatic latent image developing toner in accordance with the present invention.

The toner particles of the present invention may be manufactured by using, for example, a pulverizing method or any of the like methods, and toner particles, manufactured by a wet granulating method such as a suspension polymerization method, a dispersion polymerization method, a resin particle association method and an emulsion dispersion method, are preferably used. By manufacturing the toner particles using the wet granulating method, toner particles having a smaller particle size with a sharp particle-size distribution, are obtained at lower costs in comparison with those obtained by the pulverizing method. Among the wet granulating methods, the suspension polymerization method and the resin particle association method are preferably used, and in particular, the resin particle association method is more preferably used from the viewpoint of the degree of freedom in controlling the shape of the toner particles.

The manufacturing method in accordance with the resin particle association method refers to a method in which resin particles and colorant particles are salted-out/fusion-adhered with each other in an aqueous solvent so that a toner is manufactured. In this method, since the resin particles and the colorant particles are joined to each other, the advantage that the colorant is evenly dispersed is obtained in addition to the aforementioned effects.

The resulting toner particles have uniform surface characteristics and a sharp charge quantity distribution so that images having superior sharpness can be produced for a long period of time.

More specifically, the following description will discuss one example of a method for manufacturing an electrostatic latent image developing toner in accordance with the present invention:

(1) Polymerization process for obtaining resin particles (I)
(2) Salting-out and fusion-adhering processes in which resin particles and colorant particles (carbon black particles of the present invention) are salted out, aggregated and fusion-adhered with one another to provide toner particles (II)
(3) Filtrating and washing processes in which toner particles are filtrated from the dispersion system of toner particles, and the surface active agent and the like are removed from the toner particles.
(4) Drying process in which the toner particles that have been, washed are dried.
(5) Process for adding external additives to the toner particles that have been dried.

The respective processes are explained below.

### <<Polymerization Process (I)>>

The polymerization process is explained more specifically: First, a monomer is dispersed in an aqueous medium (aqueous solution of a surfactant) as oil droplets, and the monomer is polymerized by a water soluble polymerization initiator or an oil soluble polymerization initiator so that a dispersion solution of resin particles is prepared. In this polymerization process, the resin particles containing a release agent may be prepared by using a mini-emulsion polymerization method in which a material prepared by allowing the monomer to contain the release agent is used, or in the case when no release agent is used, an emulsion polymerization method may be used.

Here, the following method may be used as a preferable polymerization method for forming resin particles containing a release agent: A monomer solution, prepared by dissolving a release agent in a monomer, is dispersed as oil droplets in an aqueous medium prepared by dissolving a surfactant having a concentration of critical micelle concentration or less, by utilizing mechanical energy so that a dispersion solution is prepared, and a water soluble polymerization initiator is added to the resulting dispersion solution so that a radical polymerizing process is carried out in the droplets (hereinafter, referred to as “mini-emulsion method). Additionally, in place of adding the water soluble polymerization initiator, an oil soluble polymerization initiator may be added to the monomer solution, or this may be added thereto together with the water soluble polymerization initiator.

In accordance with the mini-emulsion method to mechanically form the oil droplets, different from the normal emulsion polymerization method, the release agent dissolved in the oil phase is free from being isolated so that a sufficient amount of the release agent can be introduced into resin particles or a coating layer to be formed.

With respect to the dispersing machine for carrying out an oil-droplets dispersing process by using mechanical energy, not particularly limited, for example, a stirring device with a high-speed rotating rotor “CLEARMIX” (made by M Technique), an ultrasonic dispersing machine, a mechanical homogenizer, a Monton-Gourin homogenizer and a high-pressure homogenizer may be used. Here, the dispersion particle size is set to 10 nm to 1000 nm, preferably to 50 nm to 1000 nm, more preferably to 30 nm to 300 nm.

A known method, such as an emulsion polymerization method, a suspension polymerization method and a seed polymerization method, may be used as the polymerization method for forming the resin particles or the coating layer containing a release agent. These polymerization methods may also be used for obtaining resin particles (core particles) forming composite resin particles or a coating layer, which contain neither release agent nor crystalline polyester.

The particle size of the resin particles obtained in the polymerization process (I) is preferably set in the range from 10 nm to 1000 nm in terms of weight average particle size measured by using an electrophoretic light scattering photometer “ELS-800” (made by Otsuka Electronics Co., Ltd.).

The glass transition temperature (Tg) of the resin particles is preferably set in the range from 48° C. to 74° C., more preferably from 52° C. to 64° C. The softening point of the resin particles is preferably set in the range from 95° C. to 140° C.

<<Salting-Out, Aggregating and Fusion-Adhering Processes (II)>>

These salting-out, aggregating and fusion-adhering processes (II) are processes in which resin particles obtained in the polymerization process (I) and colorant particles are salted out, aggregated and fusion-adhered with each other (the salting-out and fusion-adhering processes are carried out simultaneously) so that toner particles having irregular shapes (non-spherical shape) are obtained.

In these salting-out, aggregating and fusion-adhering processes (II), in addition to the resin particles and the colorant particles, inner additive particles of a charge control agent or the like (fine particles of about 10 nm to 1000 nm in the number average primary particle size) may be salted out, aggregated and fusion-adhered with one another.

The colorant particles, which are dispersed in an aqueous medium, are subjected to the salting-out, aggregating and fusion-adhering processes. For example, an aqueous solution in which a surfactant having a concentration of critical micelle concentration or (CMC) or more is dissolved may be used as the aqueous medium in which the colorant particles are dispersed.

With respect to the surfactant, the same surfactant as that used in the polymerization process (I) may be used.

With respect to the dispersing machine used for the dispersing process for the colorant particles (carbon black in the present invention), not particularly limited, examples thereof include pressure dispersing machines, such as a stirring apparatus with a high-speed rotating rotor “CLEARMIX” (made by M Technique), an ultrasonic dispersing machine, a mechanical homogenizer, a Manton-Gourin homogenizer and a pressure homogenizer, and media-type dispersing machines, such as a Gettman mill and a Damond Fine Mill.

In the case when the resin particles and the colorant particles are salted-out, aggregated and fusion-adhered with each other, the following processes are preferably carried out: a coagulant having not less than a critical aggregating concentration is added to a dispersion solution in which resin particles and colorant particles are dispersed, and this dispersion solution is then heated to the glass transition temperature (Tg) or more of the resin particles.

More preferably, at the point of time when the aggregated particle of the resin particles and the colorant particles has come to have a desired particle size by the coagulant, an aggregation stopping agent is used. With respect to the aggregation stopping agent, a monovalent metal salt, in particular, sodium chloride, is preferably used.

The preferable temperature range used for the salting-out, aggregating and fusion-adhering processes is from (Tg+10° C.) to (Tg+50° C.), more preferably from (Tg+15° C.) to (Tg+40° C.). In order to effectively carry out the fusion-adhering process, an organic solvent that is infinitely dissolved in water may be added thereto.

With respect to the “coagulant” used for salting-out, aggregating and fusion-adhering processes, the aforementioned alkali metal salts and alkali earth metal salts may be used.

The salting-out and aggregating processes are explained.

The “salting-out, aggregating and fusion-adhering processes” are referred to processes in which the salting-out (aggregation of the particles) process and the fusion-adhering process (elimination of interface between particles) take place simultaneously, or to reactions that allow the salting-out and fusion-adhering processes to take place simultaneously.

In order to carry out the salting-out and fusion-adhering processes simultaneously, the particles (resin particles and colorant particles) are preferably aggregated with each other under a temperature condition of the glass transition temperature (Tg) or more of the resin forming the resin particles.

Upon forming a toner by using a pulverizing method, a binder resin is melt-kneaded, and the carbon black of the present invention is added thereto and mixed.

This is then subjected to pulverizing and classifying processes so that the toner is manufactured.

<<Release Agent>>

The release agent to be used for the toner is explained.

The content of a release agent contained in an electrostatic latent image developing toner in accordance with the present invention is normally set from 1% by mass to 30% by mass, preferably from 2% by mass to 20% by mass, more preferably from 3% by mass to 15% by mass.

Low molecular weight polypropylene (number average molecular weight=1500 to 9000), low molecular weight polyethylene or the like may be added as the release agent, and examples of the preferable release agent include ester-based compounds indicated by the following general formula.

### General Formula

R₁—(OCO—R₂)ₙ, in the formula, n is an integer from 1 to 4, preferably from 2 to 4, more preferably 3 or 4, most preferably 4.

Each of R₁ and R₂ represents a hydrocarbon group that may have a substituent.

R₁: number of carbon atoms=1 to 40, preferably 1 to 20, more preferably 2 to 5.

R₂: number of carbon atoms=1 to 40, preferably 16 to 30, more preferably 18 to 26.

The following description will discuss specific examples of ester compounds represented by the above-mentioned general formula; however, the present invention is not intended to be limited thereby.

[Chemical Formula 1]

### 1) CH₃—(CH₂)₁₂—COO—(CH₂)₁₇—CH₃

### 2) CH₃—(CH₂)₁₈—COO—(CH₂)₁₇—CH₃

### 3) CH₃—(CH₂)₂₀—COO—(CH₂)₂₁—CH₃

### 4) CH₃—(CH₂)₁₄—COO—(CH₂)₁₉—CH₃

### 5) CH₃—(CH₂)₂₀—COO—(CH₂)₆—O—CO—(CH₂)₂₀—CH₃

6)

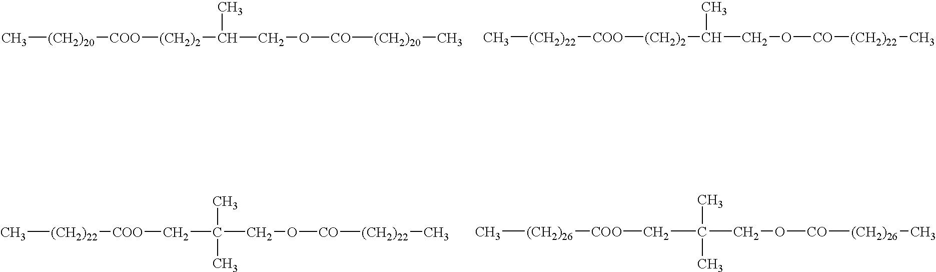

7)
8)
9)

### 10) CH₂—O—CO—(CH₂)₂₆—CH₃ 11) CH₂—O—CO—(CH₂)₂₆—CH₃

### 12) CH₂—OH

### 13) CH₂—OH CH₂—O—CO—(CH₂)₂₂—CH₃

### 14) CH₂—OH CH—OH CH₂—O—CO—(CH₂)₂₆—CH₃

### 15) CH₂—OH CH—OH CH₂—O—CO—(CH₂)₂₂—CH₃

[Chemical Formula 2]

16)
17)
18)
19)
20)
21)
22)

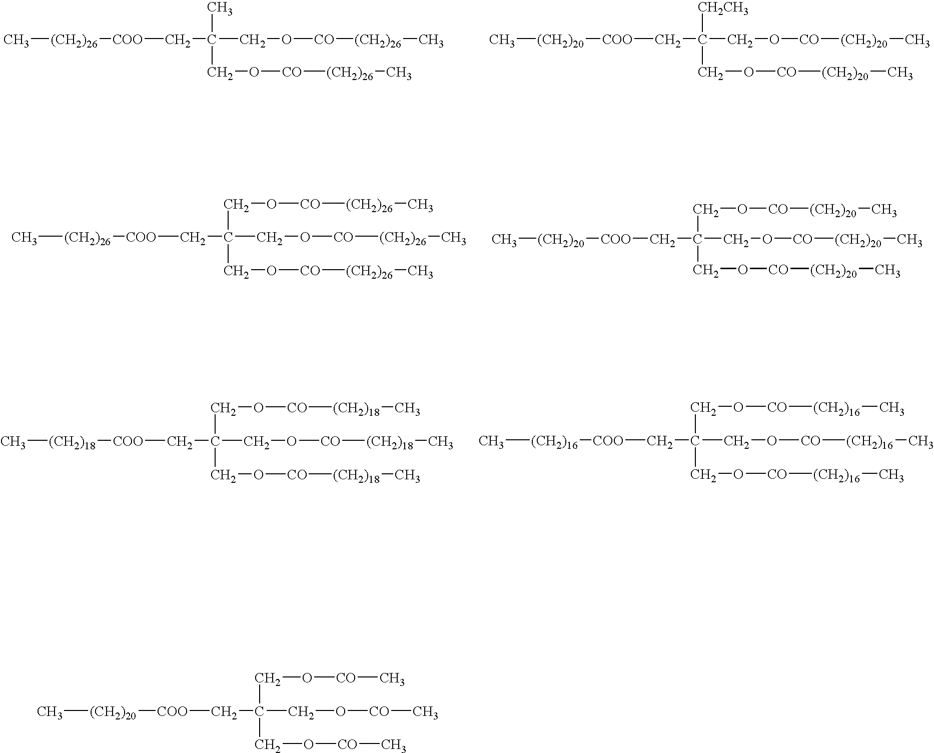

The added amount of the above-mentioned release agent and fixing improvement agent indicated by the general formula is set to 1 to 30% by mass, preferably to 2 to 20% by mass, more preferably to 3 to 15% by mass, with respect to the entire electrostatic latent image developing toner.

The following description will discuss the preferable molecular weight, range of molecular weight, peak molecular weight and the like of the resin components forming the electrostatic latent image developing toner.

The toner is preferably designed to have peaks or shoulders in the range from 100,000 to 1,000,000, as well as in a range of 1,000 to 50,000.

With respect to the molecular weight of the toner resin, those resins that contain at least two components, that is, a high molecular weight component having a peak or a shoulder in the range from 100,000 to 1,000,000 and a low molecular weight component having a peak or a shoulder in the range from 1,000 to less than 50,000, are preferably used.

The abovementioned molecular weight is measured by using a GPC (gel permeation chromatography) in which THF (tetrahydrofran) is used as a column medium.

More specifically, 1 ml of THF is added to 1 mg of a measuring sample, and this is stirred by using a magnetic stirrer at room temperature so as to be sufficiently dissolved. Next, after having been processed by a membrane filter having a pore size of 0.45 to 0.50 μm, the resulting solution is injected into a GPC. With respect to the measuring conditions of the GPC, the column is stabilized at 40° C., and the measurement is carried out by allowing THF to flow at a flow rate of 1 ml per minute, while about 100 μl of a sample having a concentration of 1 mg/ml is injected to the column. With respect to the column, commercially available polystyrene gel columns are preferably used in combination. Examples thereof include includes Shodex GPC KF-801, 802, 803, 804, 805, 806 and 807, made by Showa Denko K.K., which are used in combination, and TSKgel G1000H, G2000H, G3000H, G4000H, G5000H, G6000H, G7000H and TSK guard column, made by Tosoh Corporation, which are used in combination.

With respect to the detector, a refractive-index detector (IR detector) or an UV detector may be preferably used. With respect to the molecular-weight measurements of the sample, the molecular-weight distribution of the sample is calculated by using a calibration curve obtained by the use of single-dispersion polystyrene standard particles. With respect to calibration-curve measuring polystyrene, about ten points thereof are used.

The following description will discuss filtering-washing processes to be carried out upon manufacturing the electrostatic latent image developing toner.

In these filtering-washing processes, a filtering process for filtering and separating toner particles from the dispersion solution of the toner particles obtained from the above-mentioned processes and a washing process for removing adhering matters such as the surfactant and the coagulant from the toner particles (cake-shaped aggregate) that have been filtered and separated are carried out.

Here, with respect to the filtering treatment method, not particularly limited, a centrifugal separation method, a reduced-pressure filtering method using a nutshe or the like, a filtering method using a filter press and the like may be used.

<<Drying Process >>

In this process, the toner particles that have been washed are dried. In the drying process, a drying apparatus, such as a spray dryer, a vacuum freeze drying machine and a reduced-pressure drying machine, may be used, and a stationary rack dryer, a moving rack dryer, a fluid bed dryer, a rotary dryer and a stirring dryer are preferably used.

The moisture content of the toner particles after drying treatment is preferably set to 5% or less, more preferably to 2% or less, by weight.

Here, when the toner particles that have been dried are aggregated with one another through a weak inter-particle attracting force, the aggregate may be pulverized. In this case, with respect to the pulverizing device, a mechanical pulverizing device, such as a Jet Mill, a Henschel mixer, a coffee mill and a food processor, may be used.

The following description will discuss polymerizable monomers used for forming a toner resin by the wet polymerization method.

### (1) Hydrophobic Monomer

With respect to the hydrophobic monomer used for forming the monomer component, not particularly limited, monomers known in the art may be used. One kind or more kinds thereof may be used in combination so as to satisfy required properties.

More specifically, monomers, such as an aromatic-based mono-vinyl monomer, a (metha)acrylic acid ester-based monomer, a vinyl ester-based monomer, a vinyl ether-based monomer, a monoolefin-based monomer, a diolefin-based monomer and a halogenated olefin-based monomer, may be used.

With respect to the vinyl aromatic-based monomers, examples thereof include: styrene-based monomers and derivatives thereof, such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene and 3,4-dichlorostyrene.

With respect to the acryl-based monomer, examples thereof include: acrylic acid, methacrylic acid, methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxy acrylate, propyl γ-amino acrylate, stearyl methacrylate, dimethylaminoethyl methacrylate and diethylaminoethyl methacrylate.

With respect to the vinyl ester-based monomer, examples thereof include: vinyl acetate, vinyl propionate and vinyl benzoate.

With respect to the vinyl ether-based monomers, examples thereof include: vinyl methyl ether, vinyl ethyl ether, vinyl isobutyl ether and vinyl phenyl ether.

With respect to the monoolefin-based monomer, examples thereof include ethylene, propylene, isobutylene, 1-butene, 1-pentene and 4-methyl-1-pentene.

With respect to the diolefin-based monomer, examples thereof include butadiene, isoprene and chloroprene.

### (2) Crosslinking Monomer

In order to improve the properties of the resin particles, a crosslinking monomer may be added thereto. With respect to the crosslinking monomer, examples thereof include those monomers having two or more unsaturated bonds, such as divinyl benzene, divinyl naphthalene, divinyl ether, diethylene glycol methacrylate, ethylene glycol dimethacrylate, polyethylene glycol dimethacrylate and diallyl phthalate.

### (3) Monomer Having an Acidic Polar Group

With respect to the monomer having an acidic polar group, examples thereof include (a) α,β-ethylenic unsaturated compounds having a carboxyl group (—COOH) and (b) α,β-ethylenic unsaturated compounds having a sulfonic group (—SO₃H).

Examples of (a) α,β-ethylenic unsaturated compounds having a carboxyl group —COOH include acrylic acid, methacrylic acid, fumaric acid, maleic acid, itaconic acid, cinnamic acid, monobutyl maleic acid ester, monooctyl maleic acid ester, and metal salts such as Na and Zn of these.

Examples of (b) α,β-ethylenic unsaturated compounds having a sulfonic group (—SO₃H) include styrene sulfonate and Na salts thereof, as well as allyl sulfosuccinate, octyl allyl sulfosuccinate and Na salts of these.

The following description will discuss the initiator (referred to also as polymerization initiator) to be used for polymerizing a polymerizable monomer.

With respect to the polymerization initiator, any of those conventional initiators may be used as long as it is water-soluble. Examples thereof include persulfates (such as potassium persulfate and ammonium persulfate), azo-based compounds (such as 4,4′-azobis 4-cyano valerate and its salt, and 2,2′-azobis(2-amidinopropane)salt), and peroxide compounds such as hydrogen peroxide and benzoyl peroxide.

The above-mentioned polymerization initiator may be combined with a reducing agent, if necessary, and prepared as a redox initiator. By using the redox initiator, the polymerization activity is enhanced so that the polymerization temperature is lowered and the polymerization time can be shortened.

The polymerization temperature is set to any temperature as long as it is lowest radical generation temperature or more of the polymerization initiator; and, for example, it is set in a range of 50° C. to 80° C. Here, by using a normal-temperature starting polymerization initiator, for example, a combination of hydrogen peroxide-reducing agent (ascorbic acid or the like), the polymerization can be carried out at room temperature or a temperature close to room temperature.

The following description will discuss the chain transfer agent.

In the present invention, in order to adjust the molecular weight of resin particles to be generated by the polymerization of the polymerizable monomer, a generally-used known chain transfer agent may be adopted.

Although not particularly limited, those compounds having a mercapt group are preferably used because they provide a toner having a sharp molecular weight distribution with superior shelf life, fixing strength and anti-offsetting property. For example, those compounds having a mercapto group, such as octane thiol, dodecane thiol and tert-dodecane thiol, may be used.

Preferable examples thereof include: ethyl thioglycolate, propyl thioglycolate, butyl thioglycolate, t-butyl thioglycolate, 2-ethylhexyl thioglycolate, octyl thioglycolate, decyl thioglycolate, dodecyl thioglycolate, thioglycolate of ethylene glycol, thioglycolate of neopentyl glycol and thioglycolate of pentaerythritol.

Among these, from the viewpoint of reducing offensive odor at the time of toner heating and fixing processes, n-octyl-3-mercaptopropionic acid ester is preferably used.

In the case of the pulverizing method, known resins, such as styrene acrylic resin, styrene butadiene resin and polyester resin, may be used as the binder resin.

<<Colorant>>

The content of carbon black is preferably set in the range from 2% by mass to 20% by mass, more preferably from 3% by mass to 15% by mass, with respect to the entire toner.

<<Inner Additive Agent>>

Inner additive agents other than the release agent, such as a charge control agent, may be contained in the toner particles forming the toner of the present invention.

With respect to the charge control agent contained in the toner particles, examples thereof include Nigrosine dyes, metal salts of naphthenic acid or higher fatty acid, alkoxylated amine, quaternary ammonium salt compounds, azo-based metal complex, metal salts of salicylic acid or metal complexes thereof.

<<Developer>>

The developer is explained below.

The toner of the present invention may be used either as a mono-component developer or as a two-component developer.

When used as the mono-component developer, a non-magnetic mono-component developer or a magnetic mono-component developer that allows the toner to contain magnetic particles of 0.1 μm to 0.5 μm is listed, and both of these may be used.

The toner may be mixed with carrier to be used as a two-component developer. In this case, with respect to magnetic particles of the carrier, conventionally known materials, metals, such as iron, ferrite and magnetite and alloys between those metals and metal such as aluminum and lead, may be used. In particular, ferrite particles are preferably used. The above-mentioned magnetic particles are preferably designed to have a median diameter (D50) in the range from 15 μm to 100 μm, more preferably from 25 μm to 80 μm, on the volume basis.

The volume average particle size of the carrier may be measured typically by using a laser diffraction-type grain distribution measuring apparatus “HELOS” (made by Sympatec Co., Ltd.) with a wet dispersing device.

With respect to the carrier, those having magnetic particles further coated with resin or those carriers of a so-called resin dispersion type in which magnetic particles are dispersed in the resin are preferably used. With respect to the coating resin composition, although not particularly limited, examples thereof include olefin-based resin, styrene-based resin, styrene-acryl-based resin, silicone-based resin, ester-based resin or fluorine-containing polymer-based resin. With respect to the resin forming the resin dispersion-type carrier, not particularly limited, known resins may be used, and examples thereof include styrene-acryl-based resin, polyester resin, fluorine-based resin and phenol resin.

### BEST MODE FOR CARRYING OUT THE INVENTION

The following description will discuss the present invention based upon Examples. However, the present invention is not intended to be limited by the Examples.

[Production of Carbon Black]

### [Carbon Black 1]

To 100 parts by weight of carbon black (N220, made by Mitsubishi Chemical Co., Ltd.; number average particle size of Feret's diameter=210 nm) was added 50 parts by weight of an organic compound 48 (molecular weight=741, melting point=125° C.), and this was charged into a twin-screw extruder. This twin-screw extruder have two screws so as to carry out a mixing process, and a PCM-30 (made by Ikegai Corporation) is used. This extruder is not designed to carry out a continuous kneading process, but modified so as to carry out a stirring process by two screws with the outlet being sealed. After charging the two components into the device so as to have a degree of filling of 94%, a stirring process was carried out thereon in a heated state to a first temperature (Tp1) 160° C. (melting point +35° C.).

With respect to the stirring conditions, a first stirring velocity (Sv1) was set to 30 screw revolutions per minute, with a first processing time (T1) being set to 10 minutes; thus, the stirring process was carried out. After the stirring process, the stirred matter was sampled, and the grafted state was confirmed by using a Soxhlet extractor so that a grafted rate of about 30% was obtained. That is, it was confirmed that a grafting process was progressing on the surface of carbon black.

Then, with respect to the stirring conditions of a mixing device, a second stirring velocity (Sv2) was set to 50 screw revolutions per minute, with a second temperature (Tp2) being set to 180° C. (melting point +55° C.), so that the conditions were changed so as to provide a higher mechanical shearing force; thus, the stirring process was carried out for 60 minutes as a second processing time (T2). Thereafter, the stirred matter was cooled, and the processed carbon black was taken out. The above-mentioned organic compound was grafted onto the surface of the carbon black at a grafted rate of 91%. Here, the primary particles were present thereon at 91% on a number basis. The carbon black had a number average particle size of Feret's diameter of 42 nm. This carbon black is referred to as “carbon black 1 of the present invention”.

[Carbon Blacks 2 to 4]

The same processes as those of carbon black 1 were carried out except that the production conditions were changed as shown in Tables 1 and 2 so that carbon blacks 2, 3 and 4 were obtained.

[Carbon Black 5]

To 100 parts by weight of carbon black (N220, made by Mitsubishi Chemical Co., Ltd.) was added 80 parts by weight of an organic compound 47 (molecular weight=784, melting point=221° C.), and this was charged into a batch-type twin-screw extruder used in Example 1 so as to have a degree of filling of 94%. Next, a stirring process was carried out thereon in a heated state to 240° C. (melting point +19° C.) (Tp1). In the stirring process, the stirring velocity (Sv1) was set to 35 screw revolutions per minute, and the stirring process was carried out for 15 minutes (T1). After the stirring process, the stirred matter was sampled, and the grafted state was confirmed by using a Soxhlet extractor so that a grafted rate of about 32% was obtained. That is, it was confirmed that a grafting process was progressing on the surface of carbon black. Next, with respect to the stirring conditions of a mixing device, the stirring velocity (Sv2) was set to 55 screw revolutions per minute, with the heating temperature (the second temperature Tp2) being set to 270° C. (melting point +49° C.), so that the conditions were changed so as to provide a higher mechanical shearing force; thus, the stirring process was carried out for 70 minutes as the processing time (T2). Thereafter, the stirred matter was cooled, and the processed carbon black was taken out. The above-mentioned organic compound was grafted onto the surface of the carbon black at a grafted rate of 72%. The primary particles were present thereon at 53% on a number basis. Moreover, the carbon black had a number average particle size of Feret's diameter of 48 nm. This carbon black is referred to as “carbon black 5.”

[Carbon Blacks 6 to 9]

The same processes as those of carbon black 1 were carried out except that the production conditions were changed as shown in Tables 1 and 2 so that carbon blacks 6 to 9 were obtained.

[Carbon Black 10]

The same processes as those of carbon black 1 were carried out except that in place of carbon black (N220, made by Mitsubishi Chemical Co., Ltd.), Raven 1035 (made by Columbia Chemical Co., Ltd.) was used and that the other conditions were changed, as shown in Tables 1 and 2 so that carbon black 10 was obtained.

[Carbon Black 11]

The same processes as those of carbon black 5 were carried out except that in place of carbon black (N220, made by Mitsubishi Chemical Co., Ltd.), Raven 1035 (made by Columbia Chemical Co., Ltd.) was used and that the other conditions were changed as shown in Tables 1 and 2 so that carbon black 11 was obtained.

[Carbon Blacks 12 and 13]

The same processes as those of carbon black 1 were carried out except that the production conditions were changed as shown in Tables 1 and 2 so that carbon blacks 12 and 13 were obtained.

[Carbon Black 14]

Carbon black (N220, made by Mitsubishi Chemical Co., Ltd.) that had not been subjected to the surface treatment and the grafting process was defined as “carbon black 14.”

[Carbon Black 15]

In Example 1, after a lapse of the first processing time (T1) of one minute, a sample was taken out. This sample was defined as “carbon black 15.”

[Carbon Black 16]

The same processes as those of carbon black 1 were carried out except that the organic compound was changed to stearic acid (molecular weight=284, melting point=70° C.)(comparative compound 1) that would generate no free radicals. This was defined as “carbon black 16.”

[Carbon Black 17]

The same processes as those of carbon black 16 were carried out except that the carbon black was changed to another carbon black having a number average particle size of Feret's diameter of 500 μm.

To 100 parts of the carbon black 1 was added and mixed 155 parts of the processed carbon black so that carbon black having a number average particle size of Feret's diameter of 320 μm and a number rate of primary particles of 26% was obtained. This was defined as carbon black 17.

With respect to each of the carbon blacks 1 to 17, a number average particle size of Feret's diameter thereof and a number rate of primary particles were shown in Table 3.

TABLE 1

| | Organic compound | | | | | Difference from | | First stirring | First | |
|---|---|---|---|---|---|---|---|---|---|---|
| Carbon | | Melting | | Added | First | melting point of | Degree | velocity (number | processing | |
| black | | point | Molecular | amount | temperature | organic compound | of filling | of revolutions/ | time (minute) | Grafted |
| number | Number | (° C.) | weight | (parts) | Tp1 (° C.) | (° C.) | (%) | min) Sv1 | T1 | rate (%) |
| 1 | 48 | 125 | 741 | 50 | 160 | +35 | 94 | 30 | 10 | 30 |
| 2 | 48 | 125 | 741 | 50 | 150 | +25 | 98 | 30 | 10 | 25 |
| 3 | 48 | 125 | 741 | 50 | 150 | +25 | 98 | 30 | 10 | 25 |
| 4 | 48 | 125 | 741 | 50 | 150 | +25 | 98 | 40 | 10 | 40 |
| 5 | 47 | 221 | 784 | 80 | 240 | +19 | 94 | 35 | 15 | 32 |
| 6 | 88 | 186 | 545 | 50 | 216 | +30 | 98 | 35 | 15 | 35 |
| 7 | 115 | 84 | 481 | 50 | 104 | +20 | 97 | 30 | 5 | 32 |
| 8 | 127 | 195 | 659 | 50 | 215 | +20 | 98 | 35 | 5 | 36 |
| 9 | 128 | 132 | 791 | 50 | 145 | +13 | 91 | 30 | 5 | 26 |
| 10 | 48 | 125 | 741 | 50 | 150 | +25 | 94 | 30 | 10 | 33 |
| 11 | 47 | 221 | 784 | 80 | 231 | +10 | 98 | 30 | 10 | 35 |
| 12 | 48 | 125 | 741 | 50 | 160 | +35 | 94 | 30 | 10 | 30 |
| 13 | 48 | 125 | 741 | 50 | 150 | +25 | 98 | 30 | 5 | 15 |
| 14 | No | — | — | — | — | — | — | — | — | — |
| 15 | 48 | 125 | 741 | 50 | 150 | +25 | 94 | 30 | 1 | 2 |
| 16 | Comparative | 70 | 284 | 50 | 105 | +35 | 94 | 30 | 10 | 0 |
| | compound 1 | | | | | | | | | |

TABLE 2

| | Second | Difference from | Second stirring | | |
|---|---|---|---|---|---|
| Carbon | temperature | melting point of | velocity (number | Processing | Grafted |
| black | condition | organic compound | of revolutions/ | time (minute) | rate |
| number | Tp2 (° C.) | (° C.) | min) Sv2 | T2 | (%) |
| 1 | 180 | +55 | 50 | 60 | 91 |
| 2 | 190 | +65 | 55 | 60 | 93 |
| 3 | 220 | +95 | 60 | 60 | 95 |
| 4 | 220 | +65 | 65 | 60 | 97 |
| 5 | 270 | +49 | 55 | 70 | 72 |
| 6 | 266 | +80 | 60 | 70 | 83 |
| 7 | 174 | +90 | 55 | 40 | 93 |
| 8 | 265 | +70 | 50 | 60 | 94 |
| 9 | 210 | +78 | 50 | 40 | 91 |
| 10 | 190 | +65 | 60 | 40 | 94 |
| 11 | 250 | +29 | 55 | 40 | 90 |
| 12 | 180 | +55 | 50 | 40 | 65 |
| 13 | 190 | +65 | 55 | 10 | 35 |
| 14 | — | — | — | — | — |
| 15 | — | — | — | — | 2 |
| 16 | 125 | +55 | 50 | 30 | 0 |

[Production of Toner]

### [Production of Colorant Particle 1]

### [Preparation Example 1 for Resin Particles]

In a flask to which a stirring device had been attached, 72.0 g of the exemplified compound (19) was added to a monomer mixed solution composed of 115.1 g of styrene, 42.0 g of n-butyl acrylate and 10.9 g of methacrylic acid, and this was heated to 80° C. so as to be dissolved; thus, a monomer solution was prepared.

Here, to a separable flask (5,000 ml) equipped with a stirring device, a thermometer, a cooling pipe and a nitrogen introducing device was loaded a surface active agent solution (aqueous medium) prepared by dissolving 7.08 g of an anionic surface active agent (sodium dodecylbenzene sulfonate: SDS) in 2760 g of ion exchanged water, and this was heated to 80° C. in the inner temperature, while being stirred at a stirring speed of 230 rpm under a nitrogen gas flow.

Next, the above-mentioned monomer solution (80° C.) was mixed and dispersed in the surface active agent solution (80° C.) by using a mechanical dispersing machine “CLEARMIX” having a circulation path (made by M Technique) to prepare an emulsion solution in which emulsified particles (oil droplets) having an even dispersion particle size were dispersed.

Next, to this dispersion solution was added an initiator solution prepared by dissolving 0.84 g of a polymerization initiator (potassium persulfate: KPS) in 200 g of ion exchanged water, and this system was heated while being stirred at 80° C. for 3 hours to carry out a polymerization process. To the resulting reaction solution was added a solution prepared by dissolving 7.73 g of the polymerization initiator (KPS) in 240 ml of ion exchanged water, and after the temperature had been set to 80° C. in 15 minutes, a mixed solution composed of 383.6 g of styrene, 140.0 g of n-butyl acrylate, 36.4 g of methacrylic acid and 12 g of n-octyl mercaptan was dropped therein over 126 minutes, and after this system had been heated while being stirred at 80° C. for 60 minutes, the resulting system was cooled to 40° C. so that a dispersion solution of resin particles containing the exemplified compound (19) (hereinafter, referred to also as “latex (1)”) was prepared.

(Preparation of Dispersion Solution of Carbon Black)

Here, a surfactant solution was prepared by dissolving 59.0 parts by mass of an anionic surfactant (101) in 1600 ml of ion exchanged water, and to this was gradually added 420.0 parts by mass of carbon black 1 while being stirred, and this was then dispersed by using a “CLEARMIX” (made by M Technique) to prepare a dispersion solution of colorant particles (hereinafter, referred to also as “colorant dispersion solution 1”).

To a reaction container (four-neck flask) equipped with a temperature sensor, a cooling tube, a nitrogen gas directing device and a stirring device were charged and stirred 420.7 parts by mass of “latex (1)” (as expressed in terms of solid component equivalent), 900 parts by mass of ion exchanged water and 166 parts by mass of “colorant dispersion solution 1”. After the temperature inside the container had been adjusted to 30° C., a 5 mol/L sodium hydroxide aqueous solution was added to this solution to adjust the pH to 10.0.

Next, a solution, prepared by dissolving 12.1 parts by mass of magnesium chloride 6 hydrate in 1,000 ml of ion exchanged water, was dripped therein at 30° C. in 10 minutes, while being stirred. After having been left for 3 minutes, a heating process was started so that this system was heated to 90° C. in 6 to 60 minutes to form associated particles. In this state, the particle size of the associated particles was measured by “Coulter Counter TA-II”, and at the time when the number-average particle size was set to 4 μm, an aqueous solution, prepared by dissolving 80.4 g of sodium chloride in 1000 ml of ion exchanged water, was added thereto to stop the growth of the particles, and this was further heated and stirred for 2 hours at the liquid temperature of 98° C. as a maturing treatment so that the fusion-adhering process of the particles and the phase-separating process of the crystalline substances were continuously carried out.

This was then cooled to 30° C., and the pH was adjusted to 4.0 by adding hydrochloric acid thereto, and the stirring process was stopped. The resulting associated particles were solid/liquid separated by using a basket-type centrifugal separator “MARK III Model No. 60×40” (made by Matsumoto Kikai Mfg. Co., Ltd.) so that a cake of colored particles was formed. The cake of the colored particles was washed with water in the basket-type centrifugal separator, and then transferred into a gas-flow-type dryer and dried until the moisture content had become 0.5% by mass so that “colored particles 1” were obtained.

[Production of Colored Particles 2 to 17]

In the production method of the colorant dispersion solution used in the producing process of the colored particles 1, the same processes were carried out except that the carbon black 1 was changed to each of carbon blacks 2 to 17 so that colorant dispersion solutions 2 to 16 were produced. The same processes as those of the production of the colored particles 1 were carried out except that each of these was used in place of the colorant dispersion solution 1; thus, colored particles 2 to 17 were produced.

<<Addition of External Additives>>

To 100 parts by mass of the colored particles 1 was added 1.0 part by mass of silica, and this was mixed by a Henschel mixer for 60 minutes (peripheral velocity: 42 m/sec, mixing temperature: 38° C.) so that toner 1 was produced. The same addition processes of external additives were also carried out on the colored particles 2 to 16 so that toners 2 to 17 were obtained.

Evaluation

Each of the toners obtained in the respective Examples and Comparative Examples was set in a developing device of a monochrome printer (LP-1380) and evaluated on the following items.

### (1) Fogging

Continuous copying processes of 5000 sheets were carried out on a print pattern with a pixel rate of 6% under N/N environment (23° C., 45%). In order to evaluate fogging, images after the initial process and after endurance tests (after continuous outputs of 5000 sheets) were visually evaluated.

A: No fogging occurred in the image.
B: Although fogging slightly occurred, but there was no problem for practical use.
C: Fogging occurred, causing problems in practical use.

### (2) Charging Stability (Continuos Use)

With respect to charging stability against continuous use, one sheet was outputted in a white paper mode under the above-mentioned conditions after the initial process as well as after continuous outputs of 5000 sheets, the quantity of charge was measured on the toner on the sleeve by using a suction method, and the evaluation of charging stability was ranked as follows, based upon the difference in quantity of charge between the sheet after the initial process and the sheet after the continuous outputs of 5000 sheets.

A: The absolute value of the difference in quantity of charge was less than 5 μC/g;
B: The absolute value of the difference in quantity of charge was from 5 μC/g or more to less than 10 μC/g; and
C: The absolute value of the difference in quantity of charge was 10 μC/g or more.

### (3) Charging Stability (Environmental Fluctuations)

After continuous copying processes of 5000 sheets had been carried out on a print pattern with a pixel rate of 5% under L/L environment (10° C., 15% RH) as well as under H/H environment (30° C., 85% RH), the image density and fogging on the photosensitive member were visually observed.

A: Neither reduction in the image density nor fogging occurred under each of the environments;
B: Although a reduction in the image density and fogging slightly occurred in at least one of the environments, but there was no problem for practical use; and
C: A reduction in the image density and fogging occurred in at least one of the environments, causing problems in practical use.

### (4) Toner Scattering

By using an image-forming apparatus from which a dust-collecting filter of an evacuating unit had been removed, the toner scattering was measured by a Met One particle counter made by Pacific Scientific Instruments Co., Ltd., while copying processes of 100 sheets were being carried out on a character document with a pixel rate of 12%, and was ranked as follows:

A: The number of accumulated dust particles containing leaked toner was less than 50;
B: The number of accumulated dust particles containing leaked toner was 50 or more to less than 100;
C: The number of accumulated dust particles containing leaked toner was 100 or more to less than 500; and
D: The number of accumulated dust particles containing leaked toner was 500 or more.

Table 3 shows the results of these tests.

TABLE 3

| | | | | Number average | | | | |
|---|---|---|---|---|---|---|---|---|
| | | Number average | Rate of | particle size of | | | | |
| | Carbon | particle size of | primary particles | Feret's diameter (nm) | | | Charging stability | |
| Toner | black | Feret's diameter of | in number of | of primary particles | | Charging stability | (enviromnmental | Toner |
| number | number | carbon black (nm) | carbon black (%) | of carbon black | Fogging | (continuous use) | change) | flying |
| 1 | 1 | 42 | 65 | 25 | A | A | A | A |
| 2 | 2 | 40 | 72 | 25 | A | A | A | A |
| 3 | 3 | 39 | 89 | 25 | A | A | A | A |
| 4 | 4 | 28 | 98 | 25 | A | A | A | A |
| 5 | 5 | 48 | 53 | 28 | A | A | A | A |
| 6 | 6 | 47 | 87 | 28 | A | A | A | A |
| 7 | 7 | 41 | 89 | 28 | A | A | A | A |
| 8 | 8 | 29 | 97 | 28 | A | A | A | A |
| 9 | 9 | 36 | 77 | 28 | A | A | A | A |
| 10 | 10 | 32 | 87 | 28 | A | A | A | A |
| 11 | 11 | 33 | 83 | 28 | A | A | A | A |
| 12 | 12 | 80 | 35 | 25 | A | A | A | A |
| 13 | 13 | 180 | 7 | 25 | B | B | B | B |
| 14 | 14 | 210 | 0 | — | C | C | C | D |
| 15 | 15 | 210 | 1 | Could not | C | C | C | C |
| | | | | be measured | | | | |
| 16 | 16 | 210 | 0 | — | C | B | C | D |
| 17 | 17 | 320 | 26 | 25 | C | B | B | C |

As clearly indicated above, Examples 1 to 13 exerted superior performances in any of the evaluation items. In contrast, Examples 14 to 17 were inferior to Examples 1 to 13, and failed to provide the same effects.

### EFFECTS OF THE INVENTION

The toner of the present invention makes it possible to provide stable developing material performances for a long period of time. In particular, it can prevent fogging and toner scattering, and maintain a stable quantity of charge for a long period of time.

### BRIEF DESCRIPTION OF THE DRAWINGS

FIG. 1 is an explanatory drawing for Feret's diameter.

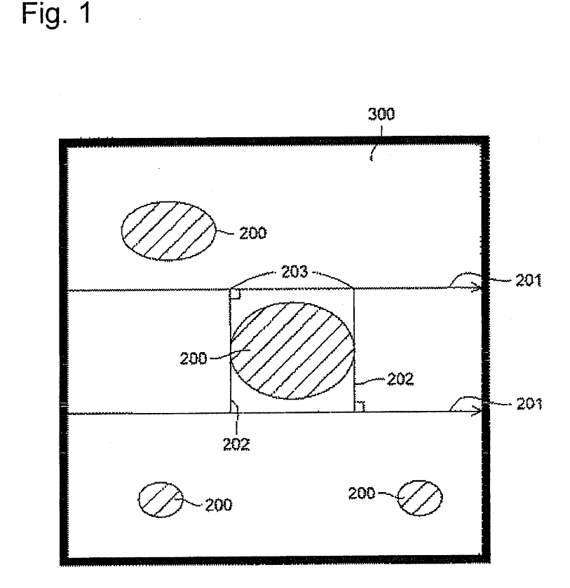

FIG. 2 is an explanatory drawing for secondary particles and basic particles.

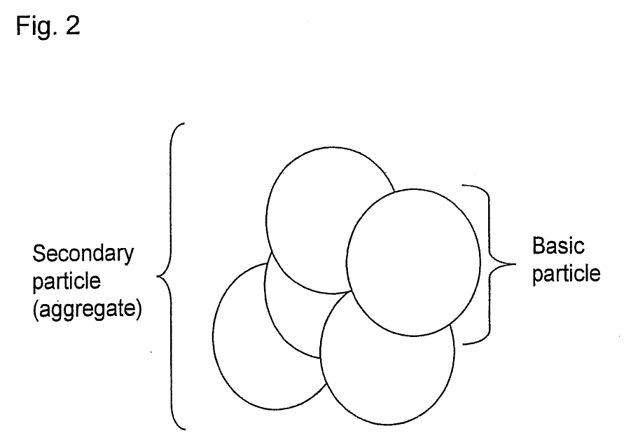

FIG. 3 is an explanatory drawing for primary particles.

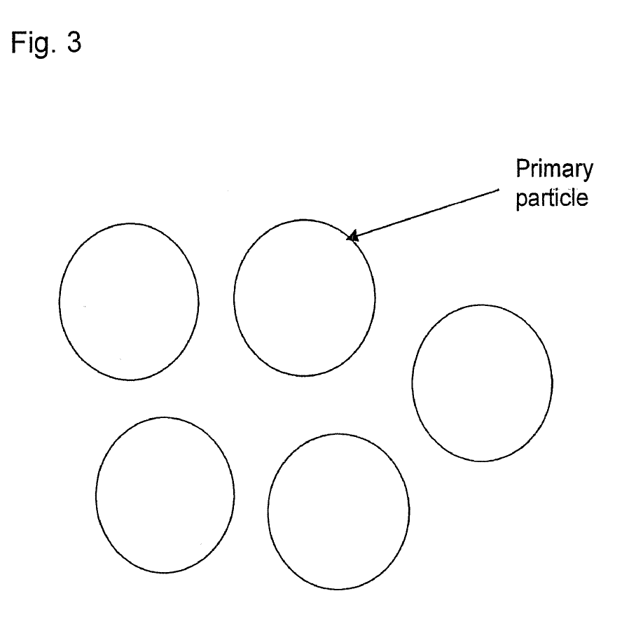

FIG. 4 is an explanatory drawing for conventional carbon black.

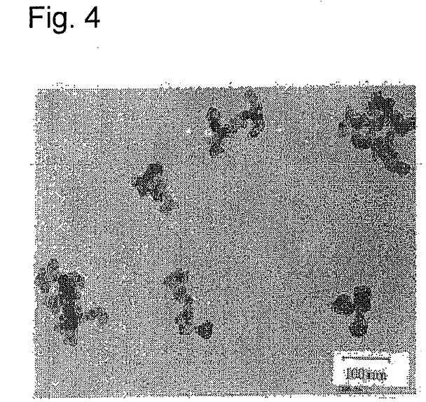

1. A toner for developing electrostatic latent images, comprising carbon black having a number average particle size of Feret's diameter of 5 to 300 nm and containing primary particles at a content of 5% or more on a number basis.

2. The toner for developing electrostatic latent images of claim 1, wherein the carbon black is surface-treated with an organic compound.

3. The toner for developing electrostatic latent images of claim 2, wherein the organic compound includes at least one of a phenol-based compound and/or an amine-based compound.
